(19) United States
(12) Patent Application Publication
(10) Pub. No.: US 2006/0192927 A1
(43) Pub. Date: Aug. 31, 2006

(54) Display

(76) Inventors: Toshio Ikeuchi, Tottori (JP); Keiji Horibe, Tottori (JP); Kenji Fukumasa, Aichi (JP); Hiroshi Maeta, Tottori (JP)

Correspondence Address: MCDERMOTT WILL & EMERY LLP, 600 13TH STREET, N.W., WASHINGTON, DC, 20005-3096, US

(21) Appl. No.: 10/551,166

(22) PCT Filed: Mar. 22, 2004
(86) PCT No.: PCT/JP04/03892

§ 371 Date: Sep. 27, 2005

(30) Foreign Application Priority Data
Mar. 27, 2003 (JP) 2003-088174
Apr. 28, 2003 (JP) 2003-123801
Apr. 28, 2003 (JP) 2003-123802
Jun. 30, 2003 (JP) 2003-186532

(51) Int. Cl. G03B 21/22

(52) U.S. Cl. 353/119

(57) ABSTRACT

A display comprises a casing (40) having a first lower air hole (36) and a first upper air hole (38), a liquid crystal display unit (12) arranged on the front side in the casing, a first power supply unit (15) arranged on the back side in the casing for supplying power to the backlight of the liquid crystal display unit, and a first cooling fan (23) so arranged on the back side in the casing that it is in the vicinity of the first upper air hole. A first circuit board (25) constituting the first power supply unit is so arranged that it is inclined to a first lateral face (42) of the casing. With this structure, reliability of the built-in power supply is improved and its temperature increase is suppressed.

### TECHNICAL FIELD

The present invention relates to a display apparatus provided with a crystal liquid panel and the like, and more particularly to a display apparatus provided with a radiating mechanism for a built-in power source. The present invention also more particularly relates to a display apparatus provided with a hard disc drive. The present invention also more particularly relates to a display apparatus whose cable set including a power plug and the like is replaceable in accordance with the destination thereof.

Furthermore, the present invention more particularly relates to a display apparatus provided with a protection circuit that protects the apparatus from abnormalities occurring at a load, such as a liquid crystal panel or the like, and at a control part, such as a CPU (Central Processing Unit) or the like.

### BACKGROUND ART

One example of a conventional display apparatus is disclosed in Japanese Patent Application Laid-open No. 2002-287109 (hereinafter referred to as “patent document 1”). This patent document 1 indicates a display apparatus having a power supply means, an image driving part, a signal processing part, and the like.

However, with the display apparatus as described in patent document 1, upsizing a display panel of the image driving part results in an increase in a power outputted by the power supply means. This results in a problem of deterioration in the reliability of the power supply means (capability of accurately outputting a predetermined voltage) and also a problem of a greater increase in the temperature of each electrical component included in each power supply part (the problems concerned with the reliability and temperature increase are collectively referred to as a “first problem”).

The display apparatus as described in patent document 1 has no storing means, and thus suffers form a problem of inability to read and write a large volume of data. Even if a hard disc drive is installed as a storing means, simply installing the hard disc drive leads to a problem of bothersome operation which requires bolts, approximately 30 pieces in quantity, fixing the rear plate of the main body to be unscrewed in order to remove the hard disc drive. Moreover, fitting a dedicated installation board leads to a problem of cost increase (the problems concerned with the inability to read and write a large volume of data, the bothersome operation, and the cost increase are collectively referred to as a “second problem”).

A conventional display apparatus whose cable set is replaceable is disclosed in, for example, Japanese Patent Application Laid-open No. H6-151023 (hereinafter referred to as “patent document 2”). According to this patent document 2, there is fitted to the front surface of a casing an identification plate indicating the commercial power supply voltage of a destination. After a male connector of a cable set (including a power plug, a cable, and the male connector) is inserted into a female connector fitted to the main body, the main body is covered by the casing, and then fastened with a dozen or so small screws.

However, with the display apparatus as described in patent document 2, the pin shape of the power plug and the pitch between pins thereof differ from one destination to another. Thus, destination change requires bothersome replacement operation, i.e., a third problem, such that the dozen or so small screws are unscrewed, the cable set is replaced with the one suitable for a new destination, and the dozen or so small screws are fastened again.

A conventional device provided with a protection circuit is disclosed in, for example, Japanese Patent Application Laid-open No. H10-234130 (hereinafter referred to as “patent document 3”). This patent document 3 indicates a protection circuit that detects load voltage and rotation speed. This protection circuit stops power supply to the load when it detects abnormality in the aforementioned voltage and rotation speed.

However, the device as described in patent document 3 suffers from a problem such that no protection circuit is provided for abnormally high temperature reached at the load or a control part, and also a problem such that no protecting means is provided for abnormal operation (e.g., running out of control) of a control part including CPU (Central Processing Unit) and the like.

Moreover, the device as described in the patent document 3 suffers from a problem such that, when power supply to the load is stopped under abnormal conditions, no automatic recovery occurs, which requires manually starting the operation of the apparatus (the problems encountered in patent document 3 are hereinafter referred to as “fourth problem”).

### DISCLOSURE OF THE INVENTION

It is an object of the present invention to provide a display apparatus that can achieve an improvement in reliability and the like.

To solve the first problem described above, it is a first object of the present invention (first aspect of the invention) to provide a highly reliable display apparatus having a power supply part whose temperature increase is controlled.

To achieve the first object described above, a display apparatus according to the first aspect of the invention includes: a casing in which a first lower vent and a first upper vent are formed; a liquid crystal display part that is arranged on the front surface side in the casing; a first power supply part that is arranged on the rear surface side in the casing and supplies a power source to a backlight of the liquid crystal display part; and a first cooling fan that is arranged on the rear surface side in the casing so as to be located near the first upper vent. In the display apparatus, a first circuit board included in the first power supply part is so arranged as to be tilted with respect to a first side surface of the casing.

As described above, the first circuit board is so arranged as to be tilted with respect to the first side surface of the casing. As a result, compared to when the first circuit board is not so arranged as to be tilted, the distance by which suction air suctioned by the first cooling fan passes through the first circuit board is smaller; therefore increases in the temperatures of the electrical components mounted on the first circuit board becomes smaller.

With the configuration of the first aspect of the present invention described above, a first partition plate is provided adjacent to the first cooling fan and the first power supply part, a first opening is provided in the first partition plate, and suction air suctioned by the first cooling fan enters through the first lower vent, passes through the first opening, the vicinity of the first power supply part, and the first cooling fan, and then is discharged through the first upper vent.

Providing the first partition plate as described above forms a first space enclosed by the first partition plate and the casing. Then, the suction air suctioned by the first cooling fan enters through the first lower vent, and passes through the first opening and the vicinity of the first power supply part. As a result, the effect of cooling down the first power supply part by the suction air improves.

With the configuration of the first aspect of the present invention described above, a second upper vent is provided in the casing, a second power supply part is provided which is arranged on the rear surface side in the casing and supplies a power source to a driving part of the liquid crystal display part, a second cooling fan is provided on the rear surface side in the casing so as to be located near the second upper vent, and a second circuit board included in the second power supply part is so arranged as to be tilted with respect to a second side surface of the casing which second side surface faces the first side surface.

Dividing a power supply section into the first power supply part and the second power supply part as described above lightens load on each power supply part. As a result, the reliability of each power supply part improves.

With the configuration of the first aspect of the present invention described above, a second partition plate is provided adjacent to the second cooling fan and the second power supply part, a second opening is provided in the second partition plate, and first suction air suctioned by the second cooling fan enters through the first lower vent, passes through the second opening, the vicinity of the second power supply part, and the second cooling fan, and then is discharged through the second upper vent.

Providing the second partition plate as described above forms a second space enclosed by the second partition plate and the casing. Then, the suction air suctioned by the second cooling fan enters through the second lower vent, and passes through the second opening and the vicinity of the second power supply part. As a result, the effect of cooling down the second power supply part by the suction air improves.

With the configuration of the first aspect of the present invention described above, a second lower vent is formed in the casing so as to be located below the second power supply part, and second suction air suctioned by the second cooling fan enters through the second lower vent, passes through the vicinity of the second power supply part and the second cooling fan, and then is discharged through the second upper vent.

With the configuration described above, since the second power supply part is cooled down by the first suction air and the second suction air, its cooling effect is profound. As a result, increases in the temperatures of electrical components included in the second power supply part become smaller.

To solve the second problem described above, it is a second object of the invention (a second aspect of the invention) to provide a low-cost display apparatus that can read and write a large volume of data and has an easily removable storage unit.

To achieve the second object described above, the display apparatus according to the second aspect of the invention includes: a main body that is formed in a substantially box-like shape and has a first opening formed in the rear surface side thereof; a liquid crystal display part that is arranged on the front surface side in the main body; a board assembly that is arranged in the main body and outputs an image signal to the liquid crystal display part; a shield plate that covers the board assembly; and a hard disc drive that is fixed to the shield plate and performs data reading and writing. In the display apparatus, the hard disc drive is so provided as to be removable through the first opening.

Providing the hard disc drive in the main body as described above permits reading and writing a large volume of data, so that a large volume of image information can be taken in through, for example, an Internet and then the large volume of image information can be displayed. The hard disc driver can be removed through the partial small window (the first opening) formed in the main body, which can be achieved easily. Further, since the hard disc drive is fixed on the shield plate, no mounting board needs to be newly arranged, thus leading to low cost.

With the configuration of the second aspect of the present invention described above, a cover is provided which covers the first opening, and is so provided as to be removable from the main body.

Arranging the cover as described above permits the operation to be performed through the cover covering the partial small window (first opening), thus achieving even easier operation of removing the hard disc drive.

With the configuration of the second aspect of the present invention described above, a reinforcing plate is provided which is in contact with opposing inner surfaces of the main body, a mounting plate is arranged which is supported by the reinforcing plate, and a circuit board included in the board assembly is supported by the mounting plate.

Consequently, the reinforcing plate improves the strength of the main body and also supports the circuit board with the mounting plate in between; therefore, the circuit board is firmly fixed. As a result, electrical components mounted on the circuit board do not become displaced, thus achieving an improvement in the quality reliability.

With the configuration of the second aspect of the present invention described above, a second opening is formed in the shield plate so as to be located below the hard disc drive, a memory is fixed to the circuit board so as to be located below the second opening, and the memory is so provided as to be removable.

With the configuration described above, operation of removing the memory is simplified. In addition, the second opening formed in the shield plate is covered by the hard disc drive, thus permitting maintaining shield performance.

To solve the third problem described above, it is a third object of the invention (a third aspect of the invention) to provide a display apparatus that permits easy replacement operation in the event of destination change.

To achieve the third object described above, the display apparatus according to the third aspect of the invention includes: a box-like main body in which a first opening is formed; a liquid crystal panel that is arranged in the main body; a first connecter that supplies a power source for the liquid crystal panel and has a conductive pin or a conductive tube formed on the front surface side thereof in a predetermined shape; a first fixing plate that fixes the first connector so that the rear surface side of the first connector protrudes into the main body through the first opening. In the display apparatus, the first fixing plate is removably fixed to the main body so that the front surface side of the first connector is exposed.

Consequently, since the first fixing plate, which fixes the first connector suitable for a destination concerned, is removably fixed, replacement of the first connector can easily be performed even in the event of destination change.

With the configuration of the third aspect of the present invention described above, a power switch is provided which is electrically connected to the first connector, the first fixing plate fixes the power switch so that the rear surface side of the power switch protrudes into the main body through the first opening, and the first fixing plate is removably fixed to the main body so that the front surface side of the power switch is exposed.

Consequently, even in the event of destination change, the power switch can easily be replaced with the one suitable for a new destination.

With the configuration of the third aspect of the present invention described above, a first vertical wall is formed in the main body, the first opening is formed in the first vertical wall, a first horizontal portion, a first vertical portion, a pawl, a second opening, and a third opening are formed in the first fixing plate, the first connector is inserted in and then fixed in the second opening, the power switch is inserted in and then fixed in the third opening, the first horizontal portion is fixed to the rear portion of the main body with a first fastening component, and the pawl is stuck in and then fixed to the first vertical wall located near the first opening.

With this configuration, the engagement or disengagement between the pawl and the first vertical wall can easily be achieved by sliding the pawl.

With the configuration of the third aspect of the present invention described above, a fourth opening is formed in the main body, there are provided: a second connector that has a second conductive tube formed on the front surface side thereof in a predetermined shape and that is electrically connected to the first connector; and a second fixing plate that fixes the second connector so that the rear surface side of the second connector protrudes into the main body through the fourth opening, and the second fixing plate is removably fixed to the main body so that the front surface side of the second connector is exposed.

Consequently, even in the event of destination change, the second connector can easily be replaced with the one suitable for a new destination.

With the configuration of the third aspect of the present invention described above, a second vertical wall is formed in the main body, the fourth opening is formed in the second vertical wall, a second horizontal portion, a second vertical portion, a bending portion, and a fifth opening are formed in the second fixing plate, the second connector is inserted in and then fixed in the fifth opening, the second horizontal portion is fixed to the rear portion of the main body with a second fastening component, and the bending portion is fixed so that the bending portion comes into contact with the inner surface of the second vertical wall located near the fourth opening.

Consequently, the engagement or disengagement between the bending portion and the second vertical wall can easily be achieved by moving the bending portion.

To solve the fourth problem described above, it is a fourth object of the invention (a fourth aspect of the invention) to provide a display apparatus which detects that the voltage of a load, the temperature of the load or a control part, or the operation of the control part is abnormal, then stops power supply, and subsequently permits automatic recovery.

To achieve the forth object described above, the display apparatus according to the fourth aspect of the invention includes: a load part that has at least a display part; a first power supply part that supplies a power source to the load part; a control part that is supplied with a power source by the first power supply part and that controls the load part; a monitoring part that monitors the load part and the control part; and a recovery part that controls the first power supply part. In the display apparatus, when the monitoring part detects the abnormality of the load part and/or the control part, the recovery part stops the supply of the power sources to the load part and the control part by the first power supply part.

Consequently, since the supply of the power sources by the first power supply part is stopped when it is detected that the load or the control part is abnormal, not only the load part but also the control part can be protected.

With the configuration of the fourth aspect of the present invention described above, when the monitoring part detects that at least one of the temperature of the load part or the control part, the voltage of the load part, and the operation of the control part is abnormal, the recovery part stops the supply of the power sources to the load apart and the control part by the first power supply part.

Consequently, in cases such as when the temperature of the load part or the control part abnormally increases or when the control part runs out of control, the load part can be protected, and also the running out of control of the control part can be stopped.

With the configuration of the fourth aspect of the present invention described above, when a predetermined period elapses after the supply of the power sources is stopped, the recovery part restarts the supply of the power sources to the load part and the control part by the first power supply part.

Consequently, since the recovery part automatically restarts power supply, bothersome manual operation for the restart, as is the case with a conventional apparatus, can be eliminated. Moreover, since, in the event of abnormality occurring at the control part or the like, the power supply is stopped and then restarted after the predetermined period, the control part and the like are more likely to perform its subsequent operation normally.

With the configuration of the fourth aspect of the present invention described above, a second power supply part may be provided whose input side is connected to a power plug, the input side of the first power supply part may be connected to the power plug, and the output side of the second power supply part may be connected to the recovery part.

Consequently, since the second power supply part constantly supplies a power source to the recovery part, the recovery part can perform control operation for automatic recovery even when the first power supply part stops the supply of the power source.

### BRIEF DESCRIPTION OF DRAWINGS

FIG. 1 is a block diagram showing the electrical configuration of a display apparatus according to a first embodiment of the present invention.

FIG. 2 shows the display apparatus of FIG. 1 as viewed from behind.

FIG. 3 is a cross section, taken on line A1-A1 of FIG. 2.

FIG. 4 is a block diagram showing the electrical configuration of a display apparatus according to a second embodiment of the invention.

FIG. 5 is an exploded perspective view of the display apparatus of FIG. 4.

FIG. 6 is a perspective view of the display apparatus of FIG. 4 with a rear plate thereof removed.

FIG. 7 is a cross section, taken on line A2-A2 of FIG. 5.

FIG. 8 is a block diagram showing the electrical configuration of a display apparatus according to a third embodiment of the invention.

FIG. 9 is a view of the display apparatus of FIG. 8 as viewed from behind.

FIG. 10 is a cross section, taken on line A3-A3 of FIG. 9.

FIG. 11A is a plan view of a first fixing plate of FIG. 9.

FIG. 11B is an elevation view of the first fixing plate of FIG. 9.

FIG. 11C is a side view of the first fixing plate of FIG. 9.

FIG. 12 is a cross section, taken on line A4-A4 of FIG. 9.

FIG. 13A is a side view of a second fixing plate of FIG. 9.

FIG. 13B is a plan view of the second fixing plate of FIG. 9.

FIG. 13C is an elevation view of the second fixing plate of FIG. 9.

FIG. 14 is a block diagram showing the electrical configuration of a display apparatus according to a fourth embodiment of the invention.

FIG. 15 is an electrical circuit diagram of a monitoring part of FIG. 14.

FIG. 16 is an electrical circuit diagram of a recovery part of FIG. 14.

FIG. 17 is a diagram of voltage waveforms at various parts of the display apparatus of FIG. 14.

### BEST MODE FOR CARRYING OUT THE INVENTION

### First Embodiment

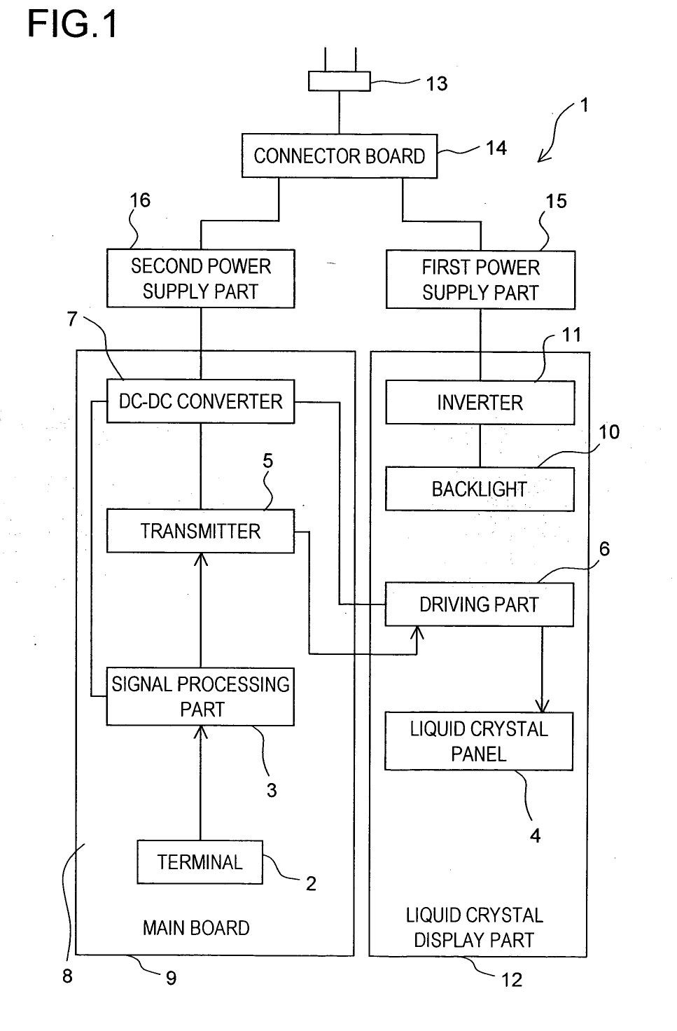

A description will be given on an embodiment, as a first embodiment, of a display apparatus of the present invention (a first aspect of invention) that achieves the first object described above. FIG. 1 is a block diagram showing the electrical configuration of the display apparatus 1 according to the first embodiment.

In FIG. 1, a terminal 2 is a component that receives a signal from outside, and formed of, for example, a USB connector, an RJ45 connector, an RS232C connecter, and/or the like. The terminal 2 is connected to, for example, one end of a LAN (Local Area Network) line (not shown) whose the other end is connected to an Internet via a server (not shown).

A signal processing part 3 includes, for example, a CPU (Central Processing Unit), a communication interface, an input part, a signal conversion part, RAM (Random Access Memory), a storage part, all not shown, and the like. When a predetermined input is fed to the input part, the CPU makes a request of a provider's server (not shown) connected to the Internet for predetermined image information (for example, advertisement data).

The image information described above is fed to the signal processing part 3 via the Internet, the server, the LAN line, and the terminal 2. The signal processing part 3 converts the fed image information into image data (R, G, B digital values) in accordance with the image size (for example, 29 inches) of a liquid crystal panel 4 (to be described below), and then outputs the resulting data to a transmitter 5.

The transmitter 5 converts the fed image data into a low voltage differential signal (LVDS), and then outputs the LVDS to a driving part 6.

A DC-DC converter 7 is a component that outputs predetermined direct voltages (for example, 12V, 5V, and 3.3V) when a direct voltage (for example, 14V) is fed. Thus, the DC-DC converter 7 outputs the predetermined voltages to the signal processing part 3, the transmitter 5, and the driving part 6, respectively.

The terminal 2, the signal processing part 3, the transmitter 5, and-the DC-DC converter 7 described above are fixed, by soldering or the like, on respective wiring patterns arranged on a main circuit board 8. These terminal 2, signal processing part 3, transmitter 5, DC-DC converter 7, main circuit board 8, and the like compose a main board 9.

The crystal liquid panel 4 is formed of, for example, two glass plates that have crystal liquid sealed therein. On the surface of the lower glass plate, there are formed in a matrix form a plurality of source electrodes and a plurality of gate electrodes, in which a thin film transistor (TFT) is formed for each pixel.

The driving part 6 includes, for example, a source driver, a gate driver, and the like. The source driver is connected to the plurality of source electrodes. The gate driver is connected to the plurality of gate electrodes. Thus, the driving part 6 drives the source electrodes and the gate electrodes arranged on the liquid crystal panel 4.

A backlight 10 illuminates the liquid crystal panel 4. An inverter 11 drives the backlight 10. These liquid crystal panel 4, driving part 6, backlight 10, the inverter 11, and the like compose a liquid crystal display part 12.

A plug 13 has the input side thereof provided with a commercial power source (not shown) and the output side thereof connected to a first power supply part 15 and a second power supply part 16 via a connector board 14. The first power supply part 15 and the second power supply part 16 each include a transformer, a rectification circuit, and the like, and supply a direct voltage of a predetermined value.

More specifically, the first power supply part 15 supplies a predetermined power source to the backlight 10 in the liquid crystal display part 12 via the inverter 11. The second power supply part 16 supplies a predetermined power source to the driving part 6 in the liquid crystal display part 12 via the DC-DC converter 7. The components described thus far provide the electrical configuration of this display apparatus 1.

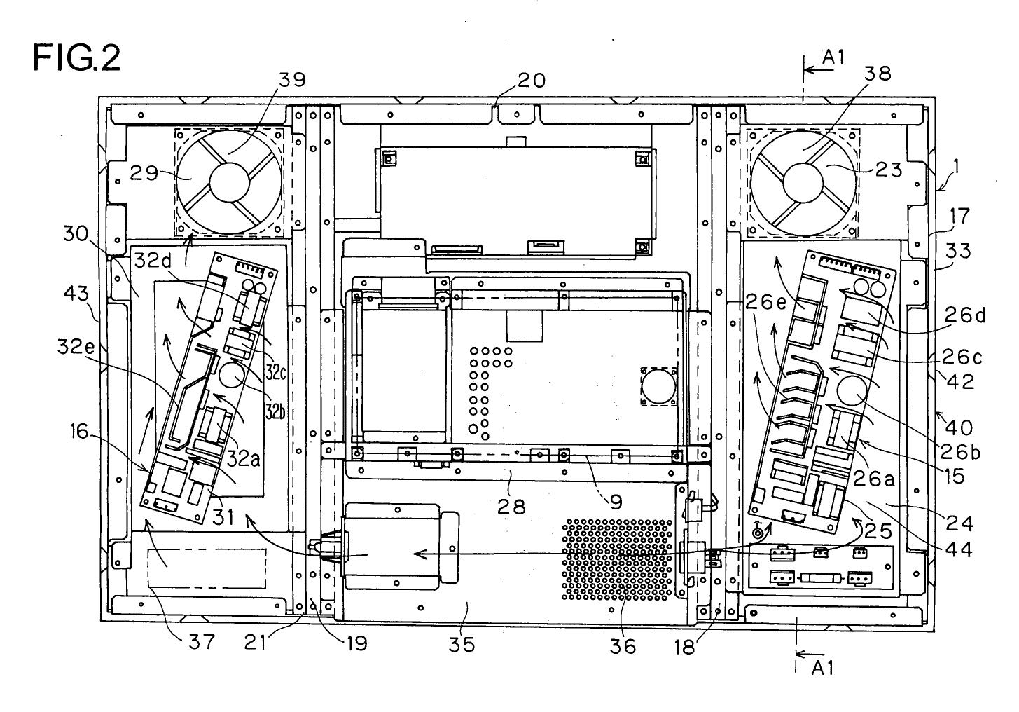

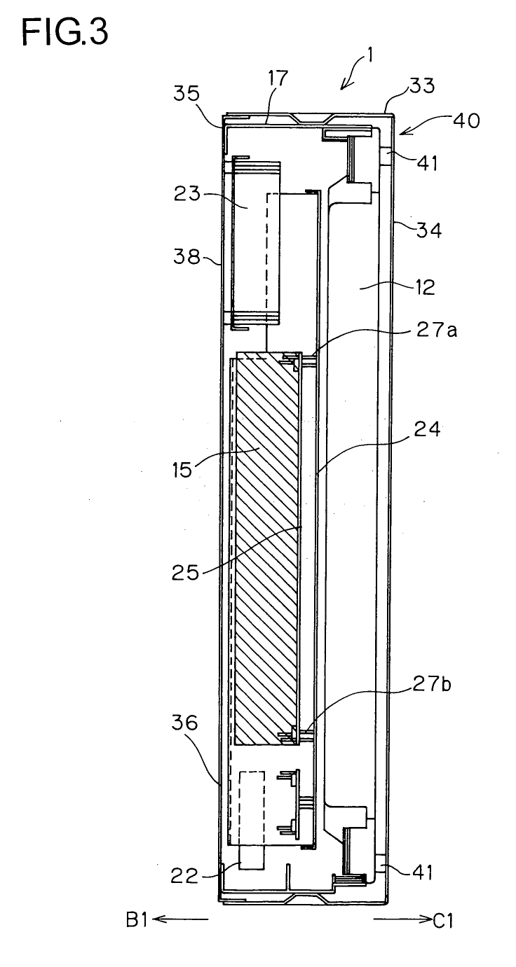

Referring to FIGS. 2 and 3, a description will be given on the mechanical structure of this display apparatus 1. FIG. 2 is a diagram of this display apparatus 1 as viewed from behind, with the rear plate thereof (a rear plate 35 to be described below) partially removed. FIG. 3 is a cross section, taken on line Al-Al of FIG. 2. The upper side, the lower side, the left side, and the right side in each of FIGS. 2 and 3 correspond to the upper side, the lower side, the left side, and the right side stated in the description. For those corresponding to what are shown in FIG. 1, they are provided with the same reference numerals, and sometimes omitted from the description.

In FIGS. 2 and 3, a frame 17 is formed of, for example, a stainless plate, in a substantially rectangular frame-like shape, and has bending portions formed at predetermined position thereof on a rear surface side B1.

A first partition plate 18 is arranged and fixed such that the top thereof is in contact with the inner surface of an upper plate 20 that forms the frame 17 while the bottom thereof is in contact with the inner surface of a lower plate 21 that forms the frame 17.

A second partition plate 19 is arranged and fixed such that the top thereof is in contact with the inner surface of the upper plate 20 while the bottom thereof is in contact with the inner surface of the lower plate 21.

The first partition plate 18 has a first opening 22 (see FIG. 3) that is formed at appropriate position thereof on the rear surface side B1. The first partition plate 18 is formed of, for example, an extruded aluminum material, which is substantially convex in cross section.

The second partition plate 19 has a second opening (not shown) that is formed at appropriate position thereof on the rear surface side B1. The second partition plate 19 is formed of, for example, an extruded aluminum material, which is substantially convex in cross section.

A first cooling fan 23 includes, for example, a fan, a fan casing, a motor, and the like. The left side of the fan casing included in the first cooling fan 23 is placed to the right of the first partition plate 18, and fixed by small screws. The right side of the fan casing is placed on the bending portion of the frame 17, and fixed with small screws.

A mounting plate 24 is, for example, a substantially U-shaped in cross section, and has bending portions formed at both the right and left ends thereof. The left bending portion formed on the mounting plate 24 is placed to the right of the first partition plate 18, and fixed with small screws. The right bending portion formed on the mounting plate 24 is placed on the bending portion of the frame 17, and fixed with small screws.

The first power supply part 15 includes, for example, a first circuit board 25, and electrical components 26a, 26b, 26c, 26d, and 26c (including a transformer, a resistor, a capacitor, a transistor, and the like) that are fixed on the first circuit board 25. The first circuit board 25 is fixed to the mounting plate 24 with spacers 27a and 27b in between.

A mounting plate 28, for example, is a substantially U-shaped in cross section, and has bending portions formed at both the right and left sides thereof. The left bending portion of the mounting plate 28 is placed to the right of the second partition plate 19, and fixed with small screws. The right bending portion of the mounting plate 28 is placed to the left of the first partition plate 18, and fixed with small screws. The main board 9 is fixed to the mounting plate 28 with spacers (not shown) in between.

A second cooling fan 29 includes, for example, a fan, a fan casing, a motor, and the like. The left side of the fan casing included in the second cooling fan 29 is placed on the bending portion of the frame 17, and fixed with small screws. The right side of the fan casing is placed to the left of the second partition plate 19, and fixed with small screws.

A mounting plate 30 is, for example, a substantially U-shaped in cross section, and has bending portions formed on both the right and left sides thereof. The left bending portion of the mounting plate 30 is placed on the bending portion of the frame 17, and fixed with small screws. The right bending portion of the mounting plate 30 is placed to the left of the second partition plate 19, and fixed with small screws.

The second power supply part 16 includes, for example, a second circuit board 31, electrical components, 32a, 32b, 32c, 32d, and 32e (including a transformer, a resistor, a capacitor, a transistor, and the like) that are fixed on the second circuit board 31. The second circuit board 31 is fixed to the mounting plate 30 with spacers (not shown) in between.

A front plate 33 is formed of, for example, a metal plate or the like, and box-shaped. The front plate 33 has an opening 34 formed in the front surface side C1 thereof. At appropriate position of the side surface of the front plate 33, there is formed a concave portion, which is in contact with the frame 17. The front plate 33 is fixed to the frame 17 with small screws.

A rear plate 35 is formed of, for example, a metal plate or the like, and has a bending portion formed on the front surface side C1 thereof. The bending portion is in contact of the inner surface of the front plate 33. The rear plate 35 is placed on the bending portion of the frame 17, the first partition plate 18, and the second partition plate 19, each fixed with small screws.

The rear plate 35 has a first lower vent 36 formed in the substantially lower center thereof and a second lower vent 37 formed in the lower left thereof. The rear plate 35 also has a first upper vent 38 formed in the upper right thereof and a second upper vent 39 formed in the upper left thereof. These frame 17, front plate 33, and rear plate 35 compose a casing 40.

The liquid crystal display part 12 includes, for example, the 29-inch liquid crystal panel 4, the driving part 6, the backlight 10, the inverter 11, and the like, and has an outer shape that is substantially rectangular parallelepiped. The liquid crystal display part 12 is fixed to the inside of the frame 17 with, for example, bolts (not shown) or the like. The front surface side C1 of the liquid crystal display part 12 is in contact with the inner surface of the front plate 33 with a packing 41 in between.

The inverter 11 may be arranged at a distance from the liquid crystal display part 12 as appropriate. The components described thus far provide the mechanical structure of this display apparatus 1.

Hereinafter, a description will be given on the unique structure of the display apparatus 1 described above. In the casing 40, the first lower vent 36 and the second lower vent 38 are formed.

The crystal liquid display part 12 is arranged on the front surface side C1 in the casing 40. The first power supply part 15 is arranged on the rear surface side B1 in the casing 40, and supplies a power source to the backlight 10 of the liquid crystal part 12 via the inverter 11.

The first cooling fan 23 is arranged on the rear surface side B1 in the casing 40 such that the first cooling fan 23 is located near the first upper vent 38. The first circuit board 25 included in the first power supply part 15 is so arranged as to be tilted (i.e., not parallel, but oblique) with respect to a first side surface 42 of the casing 40.

The first partition plate 18 is arranged adjacently to the first cooling fan 23 and the first power supply part 15. The first partition plate 18 has the first opening 22 formed therein.

Suction air D suctioned by the first cooling fan 23 enters through the first lower vent 36, and passes through the first opening 22, the vicinity of the first power supply part 15, and the first cooling fan 23 before discharged through the first upper vent 38.

The casing 40 further has the second upper vent 39 formed therein. The second power supply part 16 is arranged on the rear surface side B1 in the casing 40, and supplies a power source to the driving part 6 of the liquid crystal display part 12.

The second cooling fan 29 is arranged on the rear surface side B1 in the casing 40 near the second upper vent 39. The second circuit board 31 included in the second power supply part 16 is so arranged as to be tilted (i.e., not parallel, but oblique) with respect to a second side surface 43 of the casing 40, which second side surface 43 faces the first side surface 42.

The second partition plate 19 is arranged adjacently to the second cooling fan 29 and the second power supply part 16. The second partition plate 19 has the second opening formed therein.

First suction air E suctioned by the second cooling fan 29 enters through the first lower vent 36, and passes through the second opening, the vicinity of the second power supply part 16, and the second cooling fan 29 before discharged through the second upper vent 39.

In the casing 40, the second lower vent 37 is so formed as to be located below the second power supply part 16.

Second suction air F suctioned by the second cooling fan 29 enters through the second lower vent 37, and passes through the vicinity of the second power supply part 16 and the second cooling fan 29 before discharged through the second upper vent 39. The components described thus far compose this display apparatus 1.

Next, referring to FIGS. 1 to 3, a description will be given on the operation of this display apparatus 1. First, it is assumed that the user has plugged a plug 13 in a power receptacle (not shown), has pressed a power switch (not shown), and then made a predetermined input into the input part (keyboard, mouse, or the like) included in the signal processing part 3.

At this point, for example, image information is fed from the provider server to the signal processing part 3 via the Internet, the server, the LAN line, and the terminal 2. The signal processing part 3 converts this image information into image data, and then feeds the image data to the transmitter 5.

The transmitter 5 converts the image data into a LVDS, and then feeds this signal to the driving part 6. Subsequently, the liquid crystal panel 4 performs display operation in accordance with this LVDS. In addition, voltages are also applied to the first power supply part 15, the second power supply part 16, the first cooling fan 23, and the second cooling fan 29.

As a result, temperatures of the electrical components 26a to 26e on the first circuit board 25 and temperatures of the electrical components 32a to 32e on the second circuit board 31 start to increase.

At this point, the suction air D suctioned by the first cooling fan 23 enters through the first lower vent 36, and passes through the first opening 22, the vicinity of the first power supply part 15, and the first cooling fan 23. Then, the suction air D is discharged through the first upper vent 38. In FIG. 2, arrows with solid lines extending from the first lower vent 36 toward the first power supply part 15 via the first opening 22, and arrows with solid lines extending through the vicinity of the first power supply part 15 toward the first cooling fan 23 all indicate the flow of the suction air D

Since the first circuit board 25 is tilted with respect to the first side surface 42 of the casing 40, increases in the temperatures of the electrical components 26a to 26e mounted on the first circuit board 25 is controlled smaller than when the first circuit board 25 is not tilted.

A first space 44 enclosed by the casing 40 and the first partition plate 18 is substantially rectangular shaped as viewed on the plane surface (viewed from the direction vertical to the paper surface indicated in FIG. 2) (see FIG. 2). The first circuit board 25 is also substantially rectangular shaped as viewed on the plane surface. One side of the first circuit board 25 in the direction in which the electrical components 26a, 26b, 26c, 26d, and 26e are aligned is greater in length than the other side thereof.

Now assumed as a first example is a display apparatus having the first circuit board 25 that is not tilted with respect to the first side surface 42 of the casing 40 (i.e., first circuit board 25 that is parallel to the first side surface 42). In another word, the first example corresponds to a display apparatus in which the longitudinal direction of the first side surface 42 (vertical direction in FIG. 2) is parallel to the longitudinal direction of the first circuit board 25. In this case, therefore, as the suction air D flows more upward, its temperature gradually increases due to the electrical components 26a, 26b, 26c, and 26e mounted on the first circuit board 25. As a result, an increase in the temperature of the electrical component 26d, which is fixed on the first circuit board 25 and located at the more upper position than the electronic component 26a and others, becomes greater.

Assumed as a second example is a display apparatus having the first circuit board 25 that is tilted at 90 degrees with respect to the first side surface 42 (i.e., the first circuit board 25 is arranged horizontally). In another word, the second example corresponds to a display apparatus in which the longitudinal direction of the first side surface 42 (vertical direction in FIG. 2) is perpendicular to the longitudinal direction of the first circuit board 25. In this case, the distance at which the suction air D passes through the first circuit board 25 is shortest (shorter than those in the structure of FIG. 2 and in the first example).

Therefore, in this case, for example, the suction air D passing through the electrical component 26a is heated by the electrical component 26a only; therefore, an increase in the temperature thereof is small. The electrical component 26e located above the electrical component 26a comes into contact with the suction air D; therefore, an increase in the temperature of this electrical component 26e is small.

Thus, the inventors of the present invention have found that a greater tilt angle of the first circuit board 25 with respect to the first side surface 42 results in smaller increases in the temperatures of the electrical components 26a to 26e. However, due to the limitation imposed on the size of the first space 44, in an actual practice, the first circuit board 25 cannot be placed horizontally as is the case with the second example.

Consequently, it is better that the first circuit board 25 be arranged in such a manner as to be tilted (i.e., in such a manner as to be oblique with respect to the first side surface 42) at the maximum possible degrees within the limited size of the first space 44.

Moreover, at this point, the temperatures of the electrical components 32a to 32e mounted on the second circuit board 31 also start to increase. Then, the first suction air E suctioned by the second cooling fan 29 enters through the first lower vent 36, and passes through the second opening, the vicinity of the second power supply part 16, and the second cooling fan 29. Then, the first suction air E is exhausted through the second upper vent 39.

The second suction air F suctioned by the second cooling fan 29 enters through the second lower vent 37, and passes through the vicinity of the second power supply part 16 and the second cooling fan 29. Then the second suction air F is exhausted through the second upper vent 39.

In FIG. 2, arrows with solid lines extending from the first lower vent 36 toward the second power supply part 16 via the second opening indicate the flow of the first suction air E. An arrow with a solid line extending from the second lower vent 37 toward the second power supply part 16 indicates the flow of the second suction air F. Arrows with solid lines extending toward the second cooling fan 29 through the vicinity of the second power supply part 16 indicate the flow of the first suction air E and the second suction air F.

In this way, since the second power supply part 16 is cooled down by both the first suction air E and the second suction air F, its cooling effect is profound, thus resulting in small increases in the temperatures of the electrical components 32a to 32e included in the second power supply part 16.

As is the case with the first circuit board 25, the second circuit board 31 is also so arranged as to be tilted with respect to the second side surface 43 of the casing 40. One side of the second circuit board 31 in the direction in which the electrical components 32a, 32b, 32c, and 32d are aligned is greater in length than the other side thereof. Thus, compared to when the second circuit board 31 is not so arranged as to be tilted, the distances by which the first suction air E and the second suction air F pass through the second circuit board 31 are smaller; therefore increases in the temperatures of the electrical components 32a to 32e mounted on the second circuit board 31 become even smaller than when the second circuit board 31 is not so arranged as to be tilted.

### Second Embodiment

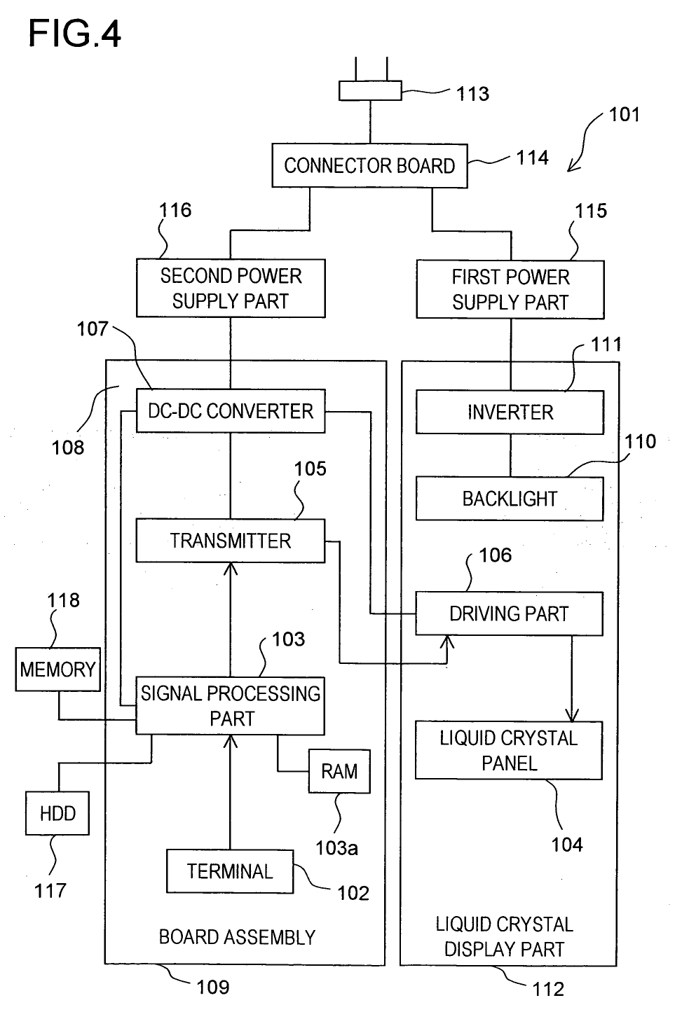

Next, a description will be given on an embodiment, as a second embodiment, of a display apparatus of the present invention (a second aspect of invention) that achieves the second object described above. FIG. 4 is a block diagram showing the electrical configuration of the display apparatus 101 according to the second embodiment.

In FIG. 4, a terminal 102 is a component that receives a signal from outside, and formed of, for example, a USB connector, an RJ45 connector, an RS232C connecter, and/or the like. The terminal 102 is connected to, for example, one end of a LAN (Local Area Network) line (not shown) whose the other end is connected to an Internet via a server (not shown).

A signal processing part 103 includes, for example, a CPU (Central Processing Unit), a communication interface, an input part, a signal conversion part, and the like. When a predetermined input is fed to the input part, the CPU makes a request of a provider's server (not shown) connected to the Internet for predetermined image information (for example, advertisement data).

The image information is fed to the signal processing part 103 via the Internet, the server, the LAN line, and the terminal 102. The signal processing part 103 converts the fed image information into image data (R, G, B digital values) in accordance with the image size (for example, 29 inches) of a liquid crystal panel (to be described below), and then outputs the resulting data to a transmitter 105.

The transmitter 105 converts the fed image data into an image signal, i.e., a low voltage differential signal (LVDS), and then outputs the LVDS to a driving part 106.

A DC-DC converter 107 is a component that outputs predetermined direct voltages (for example, 12V, 5V, and 3.3V) when a direct voltage (for example, 14V) is fed. Thus, the DC-DC converter 107 outputs the predetermined voltages to the signal processing part 103, the transmitter 105, and the driving part 106, respectively. RAM (Random Access Memory) 103a is connected to the signal processing part 103.

The terminal 102, the signal processing part 103, the transmitter 105, the DC-DC converter 107, and the RAM 103a described above are fixed on respective wiring patterns arranged on a circuit board 108 by solder or the like in between. These terminal 102, signal processing part 103, transmitter 105, DC-DC converter 107, RAM 103a, circuit board 8 and the like compose a board assembly 109.

The crystal liquid panel 104 is formed of, for example, two glass plates that have crystal liquid sealed therein. On the surface of the lower glass plate, there are formed in a matrix form a plurality of source electrodes and a plurality of gate electrodes, in which formed a thin film transistor (TFT) is formed for each pixel.

The driving part 106 includes, for example, a source driver, a gate driver, and the like. The source driver is connected to the plurality of source electrodes. The gate driver is connected to the plurality of gate electrodes. Thus, the driving part 106 drives the source electrodes and the gate electrodes arranged on the liquid crystal panel 104. A backlight 110 illuminates the liquid crystal panel 104. An inverter 111 drives the backlight 110. These liquid crystal panel 104, driving part 106, backlight 110, the inverter 111, and the like compose a liquid crystal display part 112.

Thus, the board assembly 109 outputs the image signal, LVDS, to the liquid crystal display part 112.

A plug 113 has the input side thereof provided with a commercial power source (not shown) and the output side thereof connected to a first power supply part 115 and a second power supply part 116 via a connector board 114. The first power supply part 115 and the second power supply part 116 each include a transformer, a rectification circuit, and the like, and supply a direct voltage of a predetermined value.

More specifically, the first power supply part 115 supplies a predetermined power source to the backlight 110 in the liquid crystal display part 112 via the inverter 111. The second power supply part 116 supplies a predetermined power source to the driving part 106 in the liquid crystal display part 112 via the DC-DC converter 107.

A hard disc drive (HDD) 117 is capable of reading and writing data, and has greater memory capacity than the RAM 103a. The hard disc drive 117 is connected to the signal processing part 103, so that the transmission and reception of data and the like are performed between the hard disc drive 117 and the signal processing part 103.

Memory 118 (for example, flash memory) is connected to the signal processing part 103, so that the transmission and reception of data and the like is performed between the memory 118 and the signal processing part 103. The memory 118 is fixed on the circuit board 108 as appropriate. The components described thus far provide the electrical configuration of this display apparatus 101.

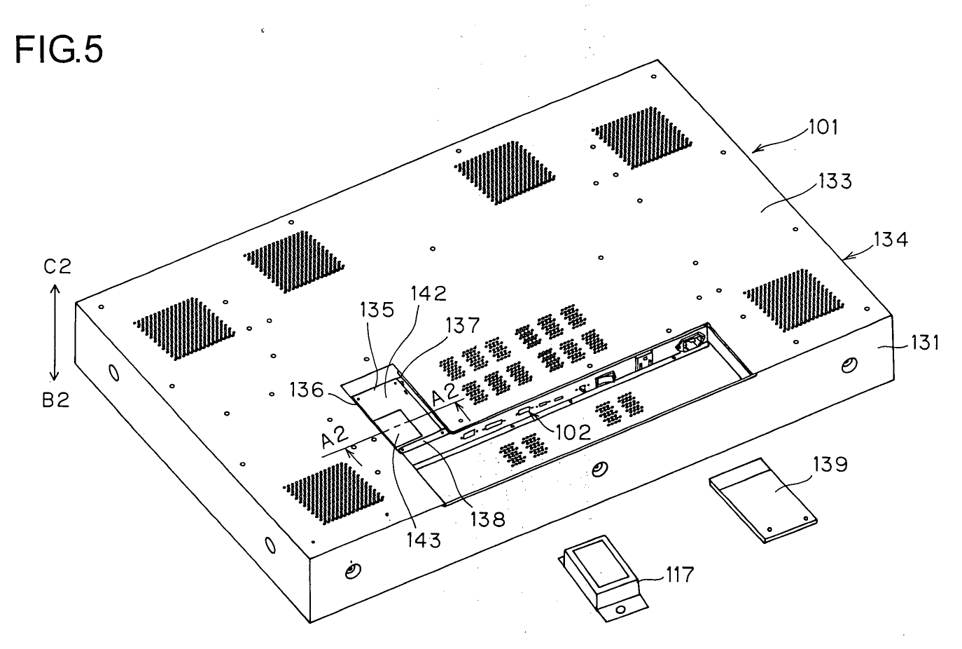

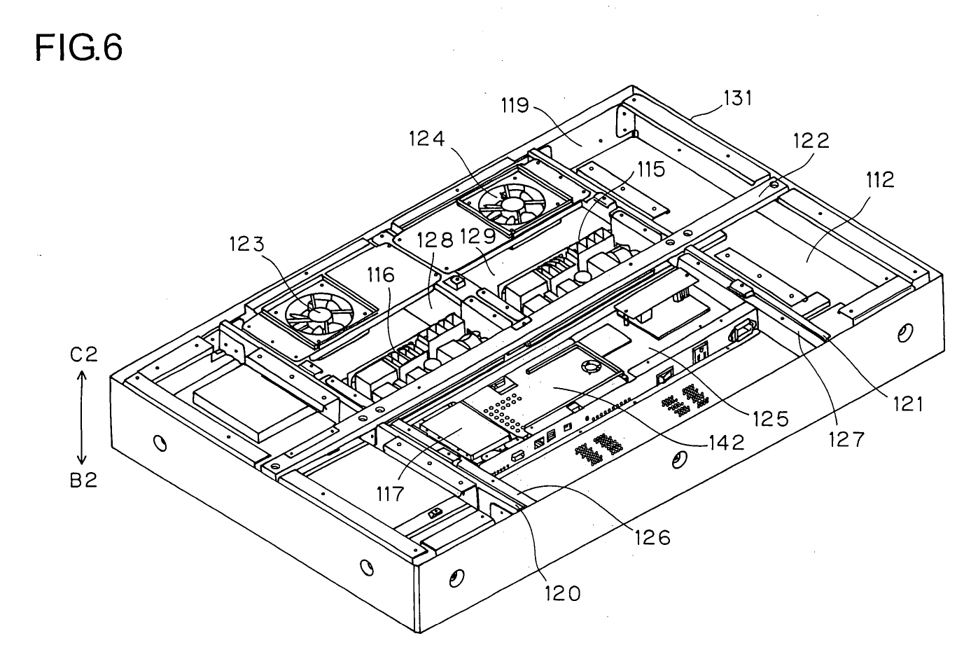

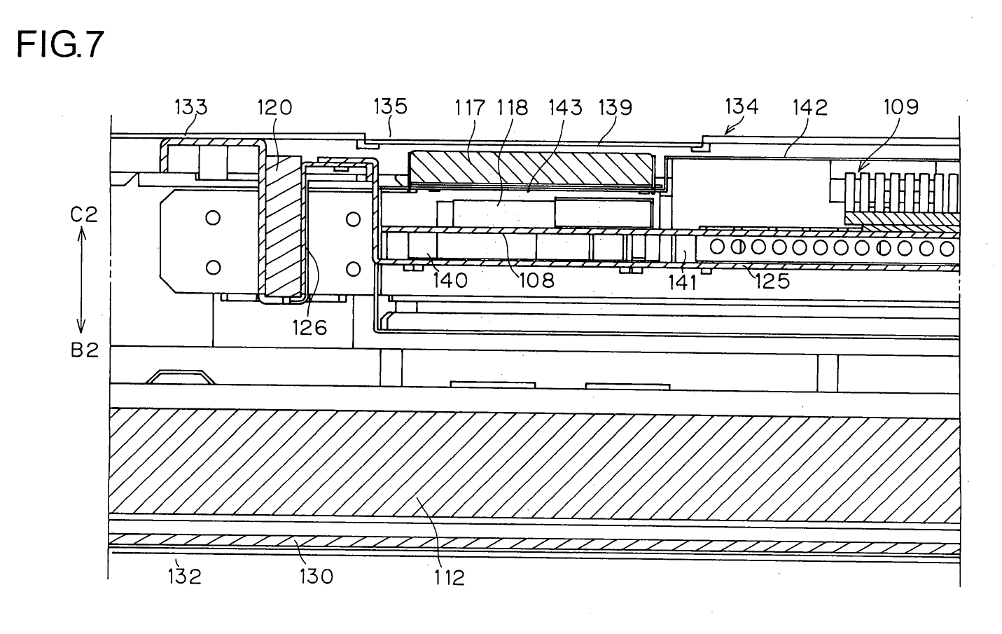

Referring to FIGS. 5 to 7, a description will be given on the mechanical structure of this display apparatus 101. FIG. 5 is an exploded perspective view of the display apparatus 101. FIG. 6 is a perspective view of the display apparatus 101 with a rear plate thereof (a rear plate 133 to be described below) removed. FIG. 7 is a cross section, taken on line A2-A2 of FIG. 5. In FIGS. 5, 6, and 7, those corresponding to what are shown in FIG. 4 are provided with the same reference numerals, and omitted from the description.

In these figures, a frame 119 is formed of, for example, a stainless plate, in a substantially frame-like shape with its front surface side and its back surface side open as viewed on the plane surface. At appropriate position of the frame 119 on a rear surface side C2, there are formed a plurality of bending portions.

Reinforcing plates 120, 121, and 122 are each formed of, for example, an aluminum extruded material, in a substantially rectangular parallelepiped shape as viewed on the plane surface.

The reinforcing plates 120, 121, and 122 each have one end thereof in contact with an inner surface of the frame 119 and the other end thereof also in contact with an inner surface of the frame 119. Thus, the reinforcing plates 120, 121, and 122 each are in contact with mutually facing inner surfaces of the frame 119, and fixed with bolts or the like.

A cooling fan 123 includes, for example, a fan, a fan casing, a motor, and the like. The left side of the cooling fan 123 is fixed to the reinforcing plate 120 with bolts.

A cooling fan 124 includes, for example, a fan, a fan casing, a motor, and the like. The right side of the cooling fan 124 is fixed to the reinforcing plate 121 with bolts.

A mounting plate 125 is formed of, for example, a metal plate, and has the left end thereof fixed to the reinforcing plate 120 with a fixing plate 126 in between and the right end thereof fixed to the reinforcing plate 121 with a fixing plate 127 in between. Thus, the mounting plate 125 is supported by the reinforcing plates 120 and 121.

The second power supply part 116 is fitted to a fixing plate 128. The first power supply part 115 is fitted to a fixing plate 129.

The liquid crystal display part 112 includes, for example, the 24-inch liquid crystal panel 104, a plurality of back lights 110, and the like, and has an outer shape that is substantially rectangular parallelepiped. The liquid crystal display part 112 is fixed to the inner surface of the frame 119 by bolts or the like. To the front surface side B2 of the liquid crystal display part 112, there is arranged a transparent plate 130 with a packing in between.

A casing 131 is formed of, for example, a metal plate or the like, in a box-like shape having a bottom portion. In the front surface side B2 of the casing 131, there is formed an opening 132. Through the opening 132, the transparent plate 130 and the liquid crystal display part 112 are made visible to the user from the front.

In side surfaces of the casing 131, there are formed holes. Bolts penetrate the holes and then fixed in threaded holes provided in the frame 119. The casing 131 is so arranged as to cover the frame 119 and the liquid crystal display part 112.

A rear plate 133 is formed of, for example, a metal plate or the like, so as to cover the rear surface side C2 of the frame 119. Bolts (not shown) penetrate holes formed in the rear plate 133, and then are fixed in holes located in the bending portions of the frame 119.

Thus, the rear plate 133 is fixed to the open rear surface side C2 of the casing 131. These frame 119, rear plate 133, casing 131, and the like compose a main body 134.

As described above, the liquid crystal display part 112 is arranged on the front surface side B2 in the main body 134. The board assembly 109 is arranged in the main body 134.

Next, referring to FIGS. 4 to 7, a description will be given on the features of this display apparatus 101. In these figures, at appropriate position of the rear plate 133, there is formed a first opening 135.

The main body 134 includes the frame 119, the casing 131, and the rear plate 133. The opening 132 is formed in the front surface side B2 of the casing 131. That is, the main body 134 is formed in a substantially box-like shape with the first opening 135 formed in the rear surface side C2 thereof.

Around the first opening 135 of the rear plate 133, there are formed flanges 136, 137, and 138. A cover 139 is formed of, for example, a metal plate, in a stepped shape. The stepped portion of the cover 139 (near the leading end thereof) comes into contact with the inner surface of the rear plate 133 while the cover 139 is placed on the flanges 136, 137, and 138. Two bolts (not shown) penetrate holes formed in the cover 139 and then are fixed in holes formed in the flange 138.

Thus, the cover 139, which covers the first opening 135 of the rear plate 133, is arranged. The cover 139 is so arranged as to be removable from the main body 134.

The reinforcing plates 120 and 121 each are so arranged as to be in contact with mutually facing inner surfaces of the main body 134 (more specifically, mutually facing inner surfaces of the frame 119). The mounting plate 125 is supported by the reinforcing plates 120 and 121.

The circuit board 108 composing the board assembly 109 is supported by (fixed to) the mounting plate 125 with spacers 140 and 141, and the like in between (see FIG. 7).

A shield plate 142 is formed of, for example, a plate material that shields electromagnetic waves, in a substantially box-like shape. Thus, the shield plate 142 is fitted to the circuit board 108 or the mounting plate 125 in such a manner as to cover the board assembly 109.

The hard disc driver 117 has, for example, a casing of a metal plate formed on the exterior thereof. This casing of the hard disc drive 117 has three flanges each formed with a hole therein (see FIG. 6).

The hard disc driver 117 is placed on a specified position of the shield plate 142. Three bolts penetrate the respective holes formed in the hard disc driver 117, and then are fixed in holes formed in the shield plate 142 (see FIG. 6).

To remove the hard disc drive 117, the two bolts fixing the cover 139 are unscrewed to remove the cover 139. Then, the three bolts fixing the hard disc drive 117 can be unscrewed to thereby remove the hard disc drive 117.

Thus, with the display apparatus 101, the hard disc drive 117 can be removed by removing the cover 139 without removing the entire rear plate 133. That is, the hard disc drive 117 is so arranged as to be removable through the first opening 135 formed in the main body 134.

In the shield plate 142, in a portion located below the hard disc drive (far from the second power supply part 116 but close to the reinforcing plate 120), there is formed a second opening 143 (see FIG. 5). The memory 118 is fixed on the circuit board 108 such that the memory 118 is located below the second opening 143.

To remove the memory 118, the cover 139 is removed, and then the hard disc drive 117 is removed, which permits removing the memory 118 from the circuit board 108. To fit the memory 118, the memory 118 is first fitted on the circuit board 108. Then, the hard disc drive 117 may be fitted on the shield plate 142, and then the cover 139 may be fitted on the main body 134.

Thus, the memory 118 is configured to be removable by fixing the memory 118 on the circuit board 108 such that the memory 118 is located below the second opening 143 of the shield plate 142.

### Third Embodiment

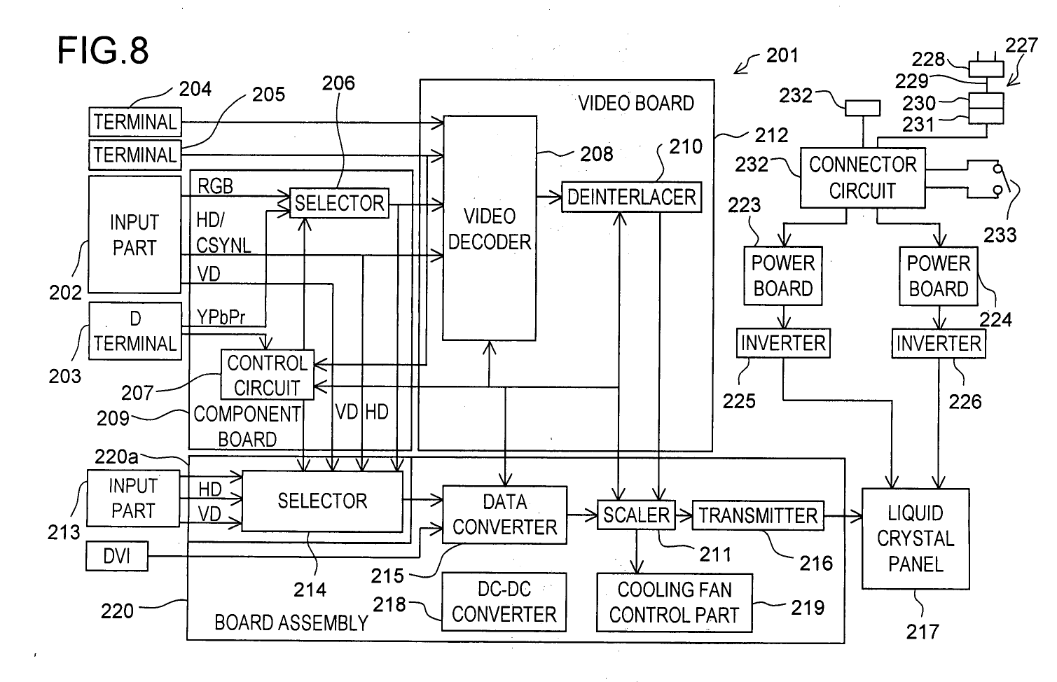

A description will be given on an embodiment, as a third embodiment, of a display apparatus of the present invention (a third aspect of invention) that achieves the third object described above. FIG. 8 is a block diagram showing the electrical configuration of the display apparatus 201 according to the third embodiment.

In FIG. 8, an input part 202 includes a connector and the like, is connected to, for example, a DVD player (not shown), and receives a video signal. Based on this video signal, the input part 202 outputs image signals R, G, and B, and synchronous signals HD/CSYNC and VD.

A D terminal 203 is connected to the DVD player, and outputs a high-quality video signal YPbPr. A terminal 204 outputs a composite video signal CVBS. A terminal 205 outputs a color signal Y/C and the like.

A selector 206 makes selection from among the video signals R, G, and B, and the high-quality video signal YPbPr based on a control signal provided from the a control circuit 207, and then outputs the selected video signal to a video decoder 208. These selector 206 and control circuit 207, and the like compose a component board 209.

The video decoder 208 receives the composite signal CVBS, the color signal Y/C, the video signal selected by the selector 206, the synchronous signal HD/CSYNC, and the like. The video decoder 208 transforms coded data into original data, and has an A/D converter built in.

A deinterlacer 210 synthesizes an ODD signal and an EVEN signal outputted by the video decoder 208, and outputs the synthesized signal to a scaler 211. These video decoder 208, deinterlacer 210, and the like compose a video board 212.

An input part 213 includes a connector and the like, and is connected to a personal computer. Upon receiving a video signal, the input part 213 outputs image signals R, G, and B, and synchronous signals HD and VD to a selector 214 based on this video signal.

A data converter 215 includes an A/D converter, and converts an input fed from the selector 214 into a digital signal and outputs it to the scaler 211. More specifically, upon receiving the fed video signals R, G, and B, the synchronous signals HD and VD, and the like, the data converter 215 digitally converts them and then outputs digital signals. The data converter 215 also outputs a dot clock signal to the scaler 211.

The scaler 211 is, for example, an IC (Integrated circuit element) that has a microcomputer and the like built in. The scaler 211 converts the digital signals, which has been converted from the image signals R, G, and B, into image data in accordance with the image size (for example, WXGA) of a liquid crystal panel 217. Thus, the scaler 211 outputs this image data to a transmitter 216.

The transmitter 216 converts the fed data into a low voltage differential signal LVDS, and outputs this LVDS to the liquid crystal panel 217. That is, upon receiving the fed image data, the transmitter 216 outputs the transmission signal LVDS to the liquid crystal panel 217.

A board assembly 220 includes: a board on which the data converter 215, the scaler 211, the transmitter 216, a DC-DC converter 218, a cooling fan control part 219 for controlling, for example, a cooling fan 237 to be described later, and the like; the data converter 215; the scaler 211; the transmitter 216; the DC-DC converter 218; the cooling fan control part 219; and the like. On a board 220a, the selector 214 is arranged. The liquid crystal panel 217 includes a liquid crystal display and a plurality of backlights (both not shown).

A cable set 227 includes a power plug 228, a cable 229, a connector 230, and the like. For example, the power plug 228 has two first conductive pins (each in the form of a round bar) spaced apart at a predetermined pitch (interval) in accordance with the specification of a destination concerned.

The cable 229 is formed of two coated lead wires. The lead wires of the cable 229 have one ends thereof connected to the respective first conductive pins of the power plug 228 and the other ends thereof connected to respective first conductive tubes of the connector 230. As a result, the first conductive pins of the power plug are electrically connected to the respective first conductive tubes of the connector 230.

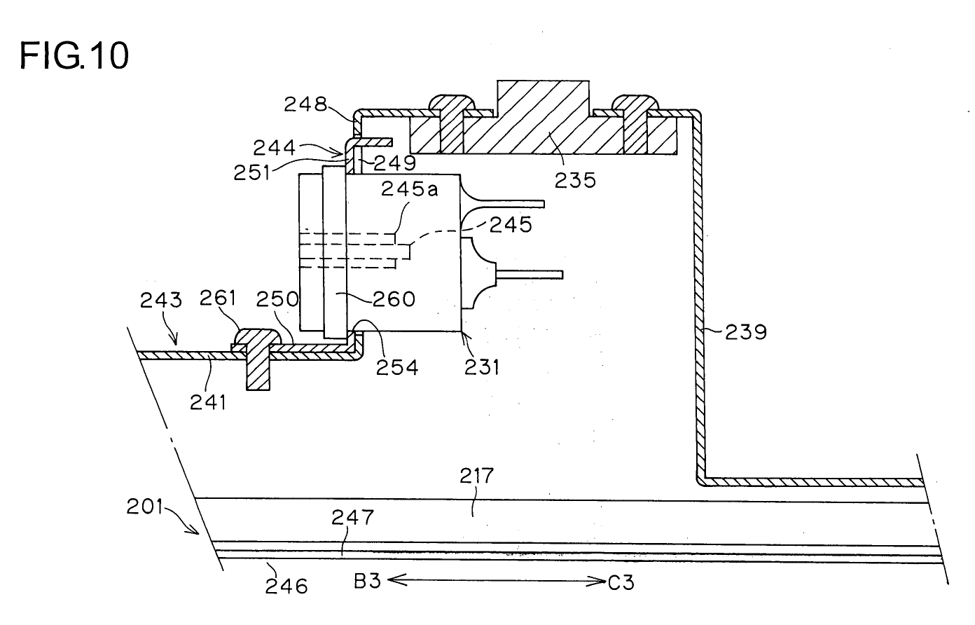

A first connector 231 has two conductive pins 245 each formed in a certain shape (for example, columnar shape). The first connector 231 has hollow portions 245a respectively formed around the two conductive pins 245 (see FIG. 10).

The first connector 231 may have a plurality of conductive tubes each formed in a certain shape (for example, cylindrical shape). Deviating from the description given above, the first connector 231 may have three conductive pins (each in a columnar shape) as appropriate.

The first conductive tubes of the connector 230 are so formed as to protrude from the front. The first conductive tubes arranged in the connector 230 and so formed as to protrude from the front are inserted into the hollow portions 245a of the first connector 231, whereby the first conductive tubes are electrically connected to the respective conductive pins 245 of the first connector 231.

Between the first connector 231 and a connector circuit 222, wiring is provided with two lead wires (only one of them is shown in FIG. 8).

A second connector 232 is formed of, for example, a female connector, and has two second conductive tubes 232a each formed in a certain shape (for example, cylindrical shape). The pitch between the second conductive tubes 232a of the second connector 232 is so provided, for example, as to agree with the pitch between the first conductive pins of the power plug 228. The second connector 232 supplies a power source to another device via a cable or the like (both not shown).

Between the second connector 232 and the connector circuit 222, wiring is provided with two lead wires (only one of them is shown in FIG. 8). Between a power switch 233 and the connector circuit 222, wiring is provided with two lead wires.

In the connector circuit 222, the lead wire on one side connected to the second connector 232 (connected to the second conductive tube 232a, on one side, of the second connector 232) is connected to the lead wire on one side connected to the first connector 231 (connected to the conductive pin 245, on one side, of the first connector 231). The lead wire on the other side connected to the second connector 232 (connected to the second conductive tube 232a, on the other side, of the second connector 232) is connected to the lead wire on the other side connected to the first connector 231 (connected to the conductive pin 245, on the other side, of the first connector 231). Thus, the second conductive tubes 232a of the second connector 232 are electrically connected to the respective conductive pins 245 of the first connector 231.

In the connector circuit 222, the lead wire on one side connected to the power switch 233 is connected to the lead wire on one side connected to the first connector 231.

Between the connector circuit 222 and a power board 223, wiring is provided with two lead wires (only one of them is shown in FIG. 8). Of the lead wires between the connector circuit 222 and the power board 223, the lead wire on one side is connected to the lead wire on the other side connected to the first connector 231 while the lead wire on the other side is connected to the lead wire on the other side connected to the power switch 233.

Similarly, between the connector circuit 222 and a power board 224, wiring is provided with two lead wires (only one of them is shown in FIG. 8). Of the lead wires between the connector circuit 222 and the power board 224, the lead wire on one side is connected to the lead wire on the other side connected to the first connector 231 while the lead wire on the other side is connected to the lead wire on the other side connected to the power switch 233. Thus, the output side of the power plug 228 is connected to the power boards 223 and 224 via the cable set 227, the first connector 231, and the connector circuit 222. A voltage applied from a commercial power source to between the two first conductive pins on the input side of the power plug 228 is supplied to the power boards 223 and 224. The power boards 223 and 224 each include a transistor, a rectifier, and the like, and supply a direct voltage that is set at a predetermined value.

The power board 223 supplies a direct voltage to an inverter 225 while the power board 224 supplies a direct voltage to an inverter 226. The inverters 225 and 226 drive the respective backlights (not shown) of the liquid crystal panel 217.

The power board 223 supplies a predetermined direct voltage to the DC-DC converter 218.

The DC-DC converter 218 supplies supply voltages respectively to the liquid crystal panel 217, the scaler 211, the selector 206, the control circuit 207, the video decoder 208, the deinterlacer 210, the selector 214, the data converter 215, the transmitter 216, the cooling fan control part 219, and the like.

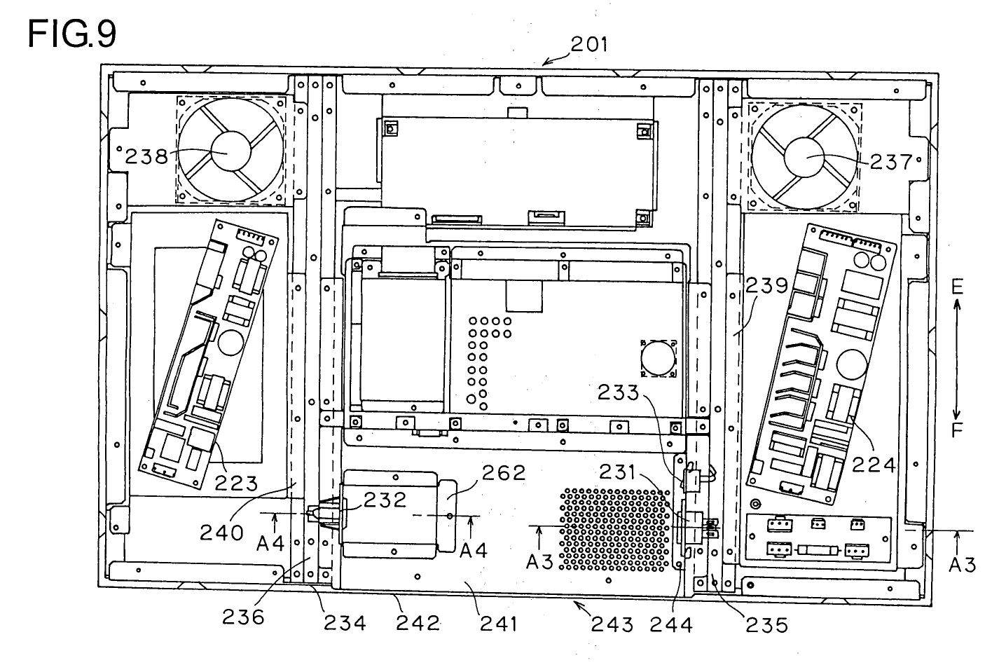

Next, referring mainly to FIG. 9, a description will be given on the mechanical structure of this display apparatus 201. FIG. 9 is a view of the display apparatus 201 as viewed from behind, with a rear plate thereof (not shown) removed. The upper side, the lower side, the left side, and the right side in FIG. 9 correspond to the upper side, the lower side, the left side, and the right side mentioned in the description. This applies similarly to FIGS. 10, 11A, 11B, 11C, 12, 13A, 13B and 13C. For those corresponding to what are shown in FIG. 8, they are provided with the same reference numerals, and sometimes omitted from the description.

In FIG. 9, a frame 234 is formed of, for example, a stainless plate, in a substantially frame-like shape with its front surface side and back surface side open as viewed on the plane surface. At appropriate position of the frame 234 on the back surface side, there are formed a plurality of bending portions.

First and second reinforcing plates 235 and 236 are each formed of, for example, an aluminum extruded material, in a substantially convex shape in cross section and a substantially rectangular parallelepiped shape as viewed on the plane surface.

The first and second reinforcing plates 235 and 236 each have one end surface thereof in contact with an inner surface of the frame 234 and the other end surface thereof also in contact with an inner surface of the frame 234. Thus, the first and second reinforcing plates 235 and 236 are fixed to the frame 234 with bolts (not shown) or the like.

A cooling fan 237 includes, for example, a fan, a fan casing, a motor, and the like. The left side of the cooling fan 237 is fixed to the first reinforcing plate 235 with bolts.

A cooling fan 238 includes, for example, a fan, a fan casing, a motor, and the like. The right side of the cooling fan 238 is fixed to the second reinforcing plate 236 with bolts.

A mounting plate 239 is formed of, for example, a metal plate or the like, and has the left end thereof fixed to the first reinforcing plate 235 with bolts and the right end thereof fixed to the frame 234 with bolts. The power board 224 is fixed on the mounting plate 239 with a spacer (not shown) in between.

A mounting plate 240 is formed of, for example, a metal plate or the like, and has the left end thereof fixed to the frame 234 with bolts. The power board 223 is fixed on the mounting plate 240 with a spacer (not shown) in between.

A rear portion 241 of the main body is formed of, for example, a metal plate or the like, and has the left end thereof fixed to the second reinforcing plate 236 with bolts and the right end thereof fixed to the first reinforcing plate 235 with bolts.

The liquid crystal panel 217 (not shown in FIG. 9) includes, for example, the 40-inch liquid crystal display, the plurality of backlights, and the like, and has an outer shape that is substantially rectangular parallelepiped. The liquid crystal panel 217 is fixed to the inside of the frame 234 with bolts or the like. To the front surface side of the liquid crystal panel 217, there is arranged a transparent plate with a packing in between (both not shown).

A casing 242 is formed of, for example, a metal plate or the like, in a box-like shape having a bottom portion. In the front surface side of the casing 242, there is formed an opening (not shown). Through the opening, the transparent plate and the liquid crystal panel 217 are made visible to the user from the front.

In a side surface of the casing 242, there are formed holes. Bolts penetrate these holes and are fixed in threaded holes provided in the frame 234. The casing 242 is so arranged as to cover the frame 234 and the liquid crystal panel 217.

A rear plate (not shown) is formed of, for example, a metal plate or the like, so as to cover the rear surface of the frame 234 excluding the rear portion 241 of the main body. Bolts (not shown) penetrate holes formed in the rear plate, and are fixed in holes located in the bending portion of the frame 234.

Thus, the rear plate (not shown) is fixed to the open rear surface side of the casing 242. As described above, these frame 234, rear portion 241 of the main body, rear plate, casing 242, and the like compose a main body 243.

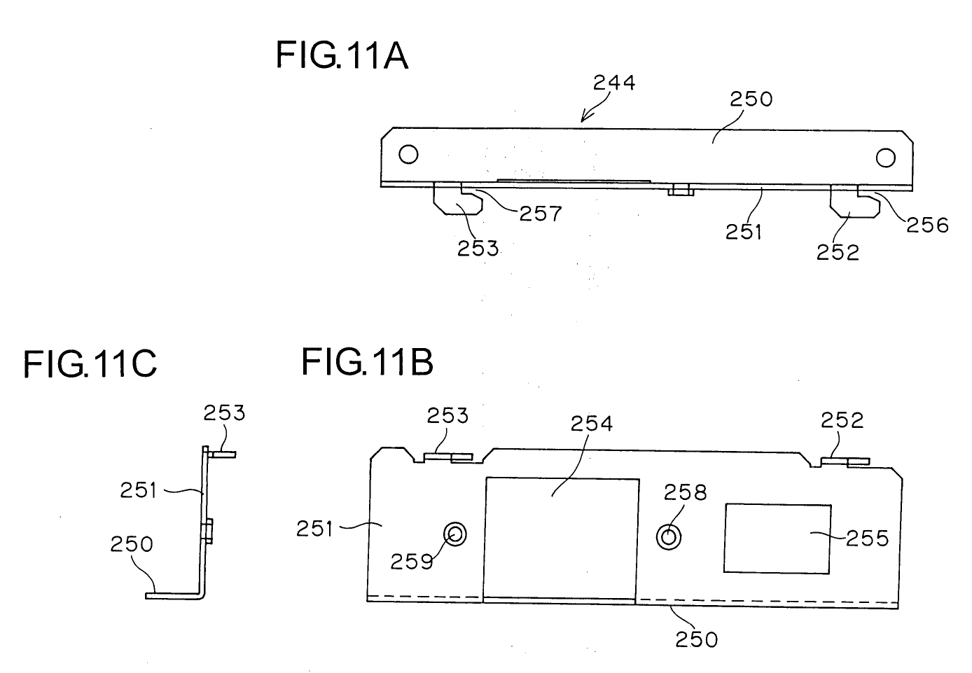

A first fixing plate 244 and a second fixing plate 262 will be described later. Next, referring mainly to FIGS. 10, 11A, 11B, and 11C, a description will be given on the structure of the first fixing plate 244 used in this display apparatus 201 and the surrounding thereof. In FIGS. 10, 11A, 11B, and 11C, for those corresponding to what are shown in FIG. 9, they are provided with the same reference numerals and omitted from the description. FIG. 10 is a cross section, taken on line A3-A3 of FIG. 9. FIG. 11A is a plan view of the first fixing plate 244. FIG. 11B is an elevation view of the first fixing plate 244. FIG. 11C is a side view of the first fixing plate 244.

In these figures, the first connector 231 has the two conductive pins 245 formed on a front surface side B3 thereof. The two conductive pins 245 are placed apart at the predetermined interval, and each formed in a predetermined shape (for example, columnar shape). The first connector 231 may have three conductive pins (one of them for grounding) as appropriate.

As described above, the first connector 231 supplies a power source for the liquid crystal panel 217. The left end of the mounting plate 239 is fixed to the right side of the first reinforcing plate 235 with bolts.

In the front surface side of the casing 242, there is formed an opening 246. To the front surface side of the liquid crystal panel 217, there is arranged a transparent plate 247 with a packing (not shown) in between. Thus, the liquid crystal panel 217 is arranged inside the main body 243.

The rear portion 241 of the main body is so formed as to be cranked (stepped). The top of the rear portion 241 of the main body is fixed to the left side of the first reinforcing plate 235 with bolts.

In the rear portion 241 of the main body, a first vertical wall 248 is a vertical portion that connects the top and the bottom. A first opening 249 is formed in the first vertical wall 248 in a shape of a substantially rectangular window.

The main body 243 is box-like shaped with the first opening 249 formed therein. The first vertical wall 248 is formed in the main body 243 (more specifically, the rear portion 241 of the main body), and the first opening 249 is formed in the first vertical wall 248.

The first fixing plate 244 is formed of, for example, a metal plate or the like. As shown in FIGS. 11A, 11B, and 11C, in the first fixing plate 244, there are formed, for example, a first horizontal portion 250, a first vertical portion 251, pawls 252 and 253, a second opening 254, a third opening 255, and the like.

The first vertical portion 251 is so bent as to be vertical to the first horizontal portion 250. The pawls 252 and 253 are so bent as to be vertical to the first vertical portion 251. The second opening 254 is formed in the first vertical portion 251 in a shape of a substantially rectangular window. The third opening 253 is formed in the first vertical portion 251 in a shape of a substantially rectangular window.

Between the pawl 252 and the first vertical portion 251, there is formed a gap 256 with a predetermined distance. Between the pawl 253 and the first vertical portion 251, there is formed a gap 257 with a predetermined distance.

At predetermined positions of the first vertical portion 251, there are respectively formed threaded holes 258 and 259. The portions described thus far compose the first fixing plate 244.

As shown in FIG. 10, the first connector 231 is inserted in the second opening 254 formed in the first fixing plate 244. In a flange 260 of the first connector 231, there is formed a hole (not shown). A bolt (not shown) penetrates the hole of the flange 260 and then fixed in the hole 259 formed in the first fixing plate 244 with screws, whereby the first connector 231 is fixed to the first fixing plate 244.

The power switch 233 is inserted in the third opening 255 formed in the first fixing plate 244. In a flange of the power switch 233, there is formed a hole (both not shown). A bolt (not shown) penetrates the hole of the flange of the power switch 233 and then fixed into the hole 258 formed in the first fixing plate 244 with screws, whereby the power switch 233 is fixed to the first fixing plate 244.

The operator inserts the pawls 252 and 253 of the first fixing plate 244 fixing the first connector 231 and the power switch 233 into the first opening 249 formed in the first vertical wall 248 located at the rear portion of the main body.

Then the operator slides the first fixing plate 244 in the direction E (see.FIG. 9), whereby the pawls 252 and 253 become stuck by the first vertical wall 248 located near the first opening 249 and thereby are fixed. More specifically, at this point, a wall portion of the first vertical wall 248 is stuck in the gap 256 between the pawl 252 and the first vertical portion 251 and in the gap 257 between the pawl 253 and the first vertical portion 251.

Next, the operator makes a first fastening component (for example, bolt) 261 penetrate a hole formed in the first horizontal portion 250 of the first fixing plate 244, and then fastens it to a hole formed in the bottom portion of the rear portion 241 of the main body. That is, the first horizontal portion 250 is fixed to the rear portion 241 of the main body with the first fastening component 261.

As shown in FIG. 10, the first fixing plate 244 fixing the first connector 231 is arranged such that the rear surface side C3 of the first connector 231 protrudes into the main body 243 through the first opening 249.

The first fixing plate 244 is removably fixed to the main body 243 such that the front surface side B3 of the first connector 231 is exposed. That is, to fit the first fixing plate 244, as described above, the operator is simply required to insert the pawls 252 and 253 into the first opening 249, to slide the pawls 252 and 253 in the direction E (see FIG. 9), and then to fasten the first fastening component 261.

To remove the first fixing 244, the operator is simply required to unscrew the first fastening component 261, to slide the pawls 252 and 253 in the direction F (see FIG. 9), and then to move the first fixing plate 244 toward the front surface side B3.

Further, as described above, the power switch 233, which is electrically connected to the first connector 231, is arranged. The first fixing plate 244 fixes the power switch 233 such that the rear surface side C3 of the power switch 233 protrudes into the main body 243 through the first opening 249. The first fixing plate 244 is removably fixed to the main body 243 such that the front surface side B3 of the power switch 233 is exposed.

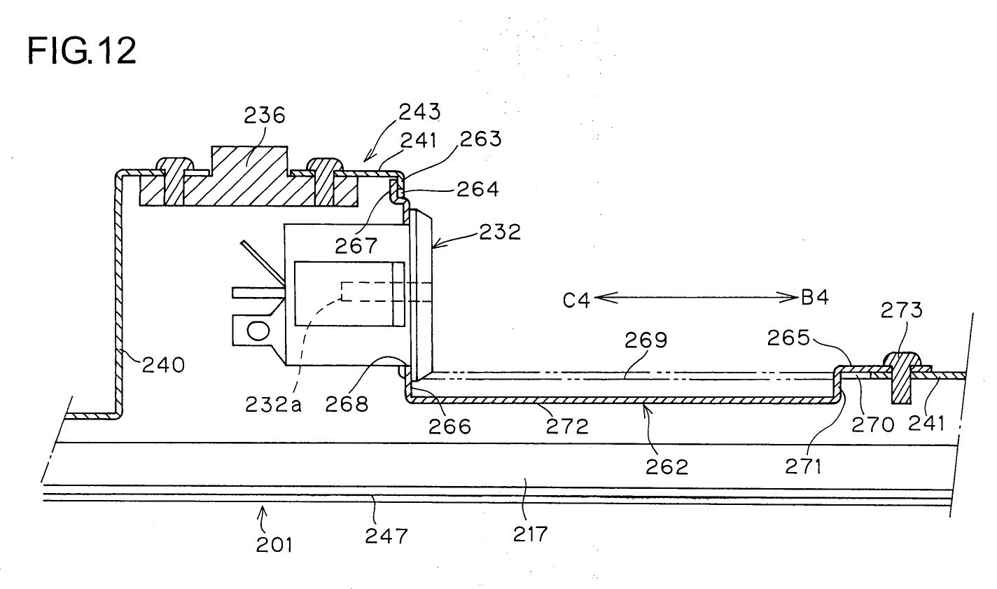

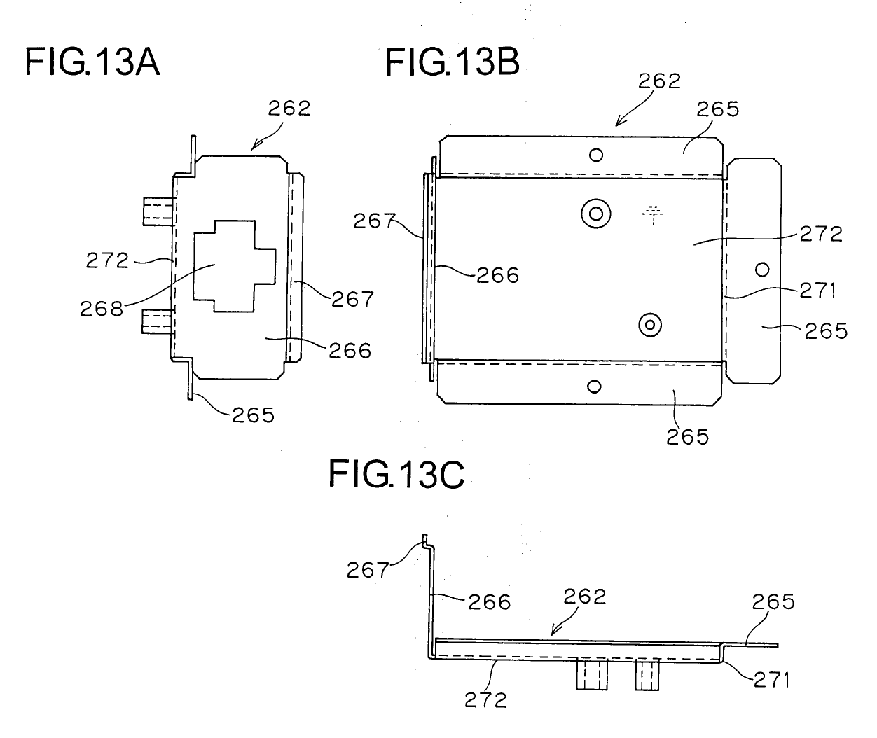

Next, referring mainly to FIGS. 12, 13A, 13B, and 13C, a description will be given on the structure of the second fixing plate 262 used in this display apparatus 201 and the surrounding thereof. In FIGS. 12, 13A, 13B, and 13C, for those corresponding to what are shown in FIGS. 9, 10, 11A, 11B, and 11C, they are provided with the same reference numerals and omitted from the description. FIG. 12 is a cross section, taken on line A4-A4 of FIG. 9. FIG. 13A is a side view of the second fixing plate 262. FIG. 13B is a plan view of the second fixing plate 262. FIG. 13C is an elevation view of the second fixing plate 262.

In these figures, the second connector 232 has the two conductive tubes 232a formed on the front surface side B4. The two conductive tubes 232a are placed apart at the predetermined interval, and each formed in a predetermined shape (for example, cylindrical shape). The second connector 232 may have three conductive tubes (one of them for grounding) as appropriate.

The second connector 232 supplies a power source to another device (both not shown) via a cable or the like. Thus, the second connector 232 has the second conductive tubes 232a formed on the front surface side B4 thereof in the predetermined shape (for example, cylindrical shape) and electrically connected to the first connector 231.

The right end of the mounting plate 240 is fixed to the left side of the second reinforcing plate 236 with bolts. The rear portion 241 of the main body is so formed as to be cranked (stepped)(see FIG. 12). The top of the rear portion 241 of the main body is fixed to the right side of the second reinforcing plate 236 with bolts.

In the rear portion 241 of the main body, a second vertical wall 263 is a vertical portion that connects the top and the bottom. A fourth opening 264 is formed in the second vertical wall 263 in a shape of a substantially rectangular window.

The second fixing plate 262 is formed of, for example, a metal plate or the like. As shown in FIGS. 12, 13A, 13B, and 13C, in the second fixing plate 262, there are formed, for example, a second horizontal portion 265, a second vertical portion 266, a bending portion 267, a fifth opening 268, and the like.

The second vertical portion 266 is so bent as to be vertical to the second horizontal portion 265. The fifth opening 268 is a window formed in a predetermined shape in the second vertical portion 266 (see FIG. 13A).

At appropriate position of the rear portion 241 of the main body, there is formed a sixth opening 269. Between a bending portion 271 of the second fixing plate 262 and the right edge of the sixth opening 269, there is provided a gap 270.

The second connector 232 is inserted in the fifth opening 268 formed in the rear portion 241 of the main body (more specifically, formed in the second fixing plate 262) to be thereby fixed to the second fixing plate 262.

The operator moves the second fixing plate 265 fixing the second connector 232 toward the front surface side B4, and places in the sixth opening 269 a concave portion 272 formed by the second horizontal portion 265, the second vertical portion 266, the bending portion 271, and the like, of the second fixing plate 262.

Then the operator tilts the second fixing plate 262 such that the concave portion 272 is oriented diagonally right up. As a result, the position of the bending portion 267 is lowered (approaches toward the liquid crystal panel 217). The operator moves the second fixing plate 262 toward the rear surface side C4 with the second fixing plate 262 in the tilted state.

Therefore, the upper end of the bending portion 267 passes through the lower end of the second vertical wall 263, so that the bending portion 267 comes into contact with the inner surface of the second vertical wall 263.

Next, the operator makes a second fastening component (for example, bolt) 273 penetrate a hole formed in the second horizontal portion 265 of the secondary fixing plate 262, and then fastens it to a hole formed in the rear portion 241 of the main body 243, whereby the second fixing plate 262 is easily fitted to the main body 243.

That is, the second horizontal portion 265 is fixed to the rear portion 241 of the main body with the second fastening component 273. The bending portion 267 comes into contact with and fixed to the inner surface of the second vertical wall 263 located near the fourth opening 264.

Thus, the second fixing plate 262 fixing the second connector 232 is arranged such that the rear surface side C4 of the second connector 232 protrudes into the main body 243 through the fourth opening 264. The second fixing plate 262 is removably fixed to the main body 243 such that the front surface side B4 of the second connector 232 is exposed.

More specifically, to remove the second fixing plate 244, the operator unscrews the second fastening component 273, and then removes the bending portion 267 from the inner surface of the second vertical wall 263 so that the concave portion 272 is oriented diagonally right up. The operator then can easily remove the second fixing plate 244 from the main body 243 by moving the second fixing plate 244 toward the front surface side B4. The operation for fitting the second fixing plate 262 to the main body 243 is as described previously. The components described thus far compose this display apparatus 201.

### Fourth Embodiment

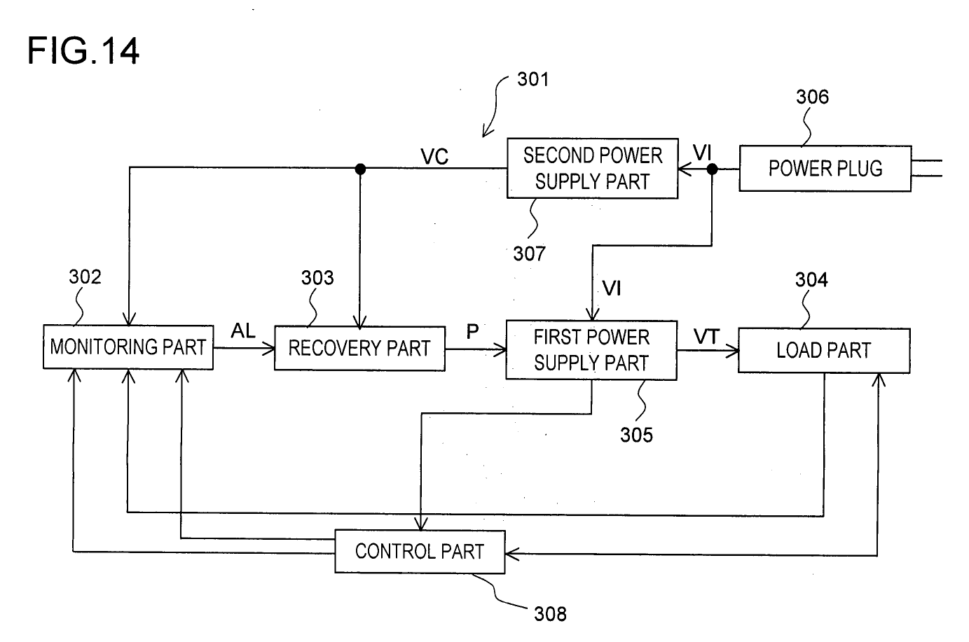

Referring to FIGS. 14 to 16, a description will be given on an embodiment, as a fourth embodiment, of a display apparatus of the present invention (a fourth aspect of invention) that achieves the fourth object described above.

FIG. 14 is a block diagram showing the electrical configuration of the display apparatus 301 (hereinafter sometimes simply referred to as “apparatus 301”) according to the fourth embodiment. In the fourth embodiment, the description refers to a display apparatus as an example of an apparatus to which the present invention is applied. However, apparatuses to which the present invention is applicable are not limited to display apparatus; therefore, the display apparatus of the fourth embodiment can be read as (replaced with) an apparatus provided with a protection circuit. That is, in the description below, all the statements “display apparatus 301 or apparatus 301” can be directly read as (replaced with) “apparatus 301 provided with a protection circuit”.

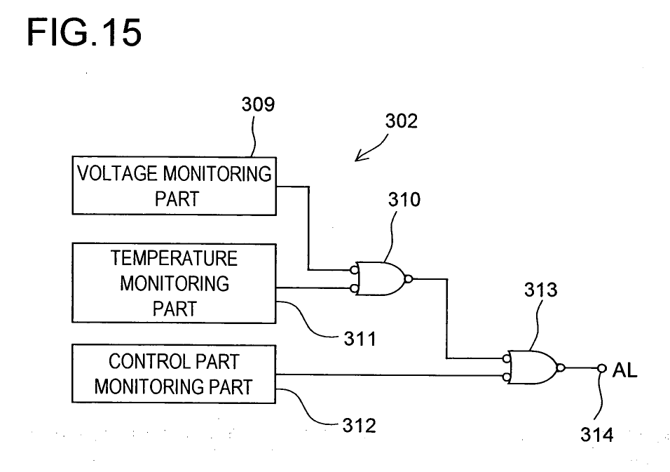

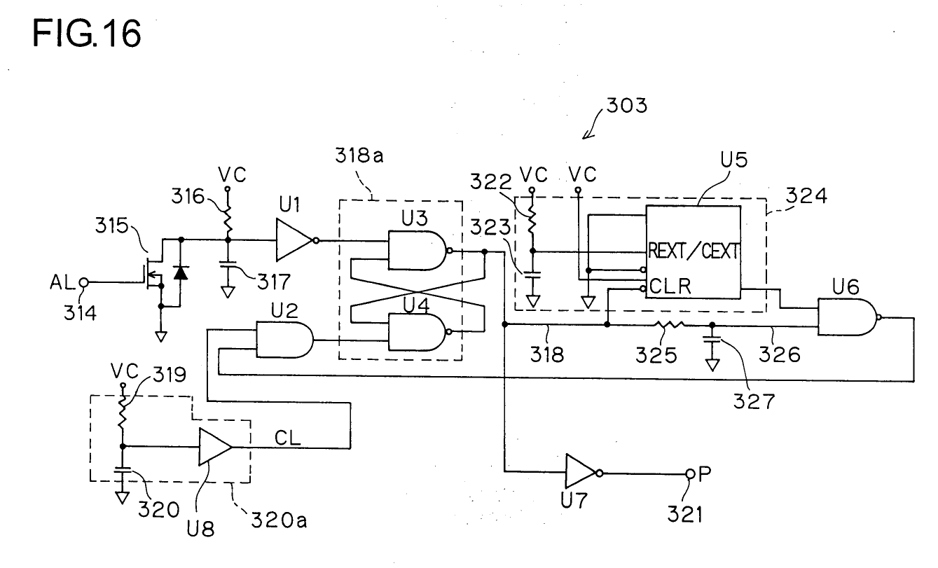

FIG. 15 is an electrical circuit diagram of a monitoring part 302 used in the apparatus 301. FIG. 16 is an electrical circuit diagram of a recovery part 303 used in the apparatus 301.

In these figures, since this apparatus 301 is a display apparatus, a load part 304 has at least a display part (not shown). This display part includes, for example, a DC/DC converter, an inverter, a backlight, a driving part, a liquid crystal panel, a transmitter, a signal processing part, and the like.

A first power supply part 305 includes, for example, a transformer, a rectifier, a switching circuit, and the like, and has the input side thereof connected to the output side of a power plug 306. The input side of the power plug 306 is inserted in a power receptacle (not shown) to be supplied with a commercial power source. The output side of the first power supply part 305 is connected to the load part 304 and also to a control part 308.

Thus, the first power supply part 305 receives a commercial supply voltage VI (for example, alternating current 100 volts). The first power supply part 305 supplies a voltage VT (for example, direct current 14 volts) (supplies a power source) to the load part 304 and a voltage VP (for example, direct current 5 volts) (supplies a power source) to the control part 308.

A second power supply part 307 includes, for example, a transformer, a rectifier, and the like, and has the input side thereof connected to the output side of the power plug 306. The output side of the second power supply part 307 is connected to a power supply terminal (not shown) of a recovery part 303 and a power supply terminal (not shown) of a monitoring part 302.

Thus, the second power supply part 307 receives a commercial supply voltage VI. Then, the second power supply part 307 supplies a voltage VC (for example, direct current 5 volts) (supplies a power source) to the recovery part 303 and the monitoring part 302, respectively. The control part 308 includes, for example, a CPU and the like, and is connected to ROM (Read Only Memory) (not shown) and the like. The control part 308 is to be supplied with the voltage VP from the first power supply part 305, and then controls the load part 304 and the like in accordance with a control program stored in the ROM.

The input side of the monitoring part 302 is connected to the load part 304 to monitor the voltage of the load part 304, and also to the control part 308 to monitor the operating condition and the temperature condition of the control part 308. Thus, the monitoring part 302 is provided to monitor the load part 304 and the control part 308. The output side of the monitoring part 302 is connected to the input side of the recovery part 303. The monitoring part 302 outputs an alert signal AL to the recovery part 303.

The input side of the recovery part 303 is connected to the monitoring part 302. The output side of the recovery part 303 is connected to a control terminal (not shown) of the first power supply part 305 so that the recovery part 303 outputs a control signal P to the first power supply part 305.

That is, the recovery part 303 controls the first power supply part 305. The components described thus far (the monitoring part 302, the recovery part 303, the load part 304, the first power supply part 305, the power plug 306, the second power supply part 307, and the control part 308) and the like compose the apparatus 301.

Next, referring to FIGS. 14 and 15, a description will be given on the monitoring part 302. In FIG. 15, a voltage monitoring part 309 includes, for example, a comparator, a logic circuit, and the like, and has the input side thereof connected to the input side of the load part 304. The output side of the voltage monitoring part 309 is connected to one input side of a negative logic OR circuit 310.

The voltage monitoring part 309 outputs a high (high potential) signal when the voltage of the load part 304 is normal (for example, in the range from 13 to 15 volts). The voltage monitoring part 309 outputs a low (low potential) signal when the voltage of the load part 304 is abnormal (for example, less than 13 volts or over 15 volts). Thus, the voltage monitoring part 309 detects whether the voltage of the load part 304 is normal or abnormal.

A temperature monitoring part 311 includes, for example, a thermistor, a logic circuit, and the like. The thermistor is arranged, for example, on the control part 308. Alternatively, a temperature sensing part may be incorporated in the control part 308 so that the temperature sensing part may be connected to the logic circuit described above via a conductive part (not shown). Thus, the temperature monitoring part 311 detects whether the temperature of the control part 308 is normal or abnormal.

The thermintor included in the temperature monitoring part 311 may be arranged in the load part 304. That is, the thermintor described above may be arranged on a circuit board (not shown) included in the load part 304. Alternatively, the thermistor may be so arranged as to detect the ambient temperature of this circuit board.

Namely, although FIG. 14 shows the electrical configuration such that only the temperature condition of the control part 308 is monitored, the temperature monitoring part 311 may be configured to detect whether the temperature of the load part 304, instead of the control part 308, is normal or abnormal. Moreover, the normality or abnormality of the temperatures of both the control part 308 and the load part 304 may be detected by, for example, providing a plurality of thermistors.

When the temperature of the load part 304 or the temperature of the control part 308 is normal (for example, within the corresponding acceptable values), the temperature monitoring part 311 outputs a high signal. When the temperature of the load part 304 or the temperature of the control part 308 is abnormal (for example, over the corresponding acceptable values), the temperature monitoring part 311 outputs a low signal.

When the temperature monitoring part 311 simultaneously monitors the normality and abnormality of the temperatures of both the control part 308 and the load part 304, the temperature monitoring part 311 outputs a low signal when at least one of the temperatures of the control part 308 and the load part 304 is abnormal, and outputs a high signal when both of the temperatures are normal.

The output side of the temperature monitoring part 311 is connected to the other input side provided in the negative logic OR circuit 310.

A control part monitoring part 312 includes, for example, a watchdog timer and the like, and has the input side thereof connected to the control part 308. The output side of the control part monitoring part 312 is connected to one input side provided in a negative logic OR circuit 313.

The control part 308 periodically accesses the control part monitoring part 312. When the control part monitoring part 312 detects this access, the control part monitoring part 312 judges that the operation of the control part 308 is normal, and then outputs a high signal.

On the other hand, when the control part monitoring part 312 does not detect this access, the control part monitoring part 312 judges that the operation of the control part 308 is abnormal (for example, running out of control), and then outputs a low signal.

The output side of the negative logic OR circuit 310 is connected to the other input side provided in the negative logic OR circuit 313. The output side provided in the negative logic OR circuit 313 is connected to an output terminal 314.

With the configuration described above, when at least one of the voltage monitoring part 309, the temperature monitoring part 311, and the control part monitoring part 312 detects the abnormality (output of a low signal) of a corresponding monitoring subject, a low signal is fed to the output terminal 314.

On the other hand, when all of the voltage monitoring part 309, the temperature monitoring part 311, and the control part monitoring part 312 detect the normality (output of high signals) of corresponding monitoring subjects, a high signal is fed to the output terminal 314.

Then the output terminal 314 is connected to the input side of the recovery part 303 so that an alert signal AL fed to the output terminal 314 can be transmitted to the recovery part 303.

Next, mainly according to FIG. 16, a description will be given on the recovery part 303. In FIG. 16, a parallel circuit 315 is formed by an FET (field effect transistor) and a diode that are connected in parallel to each other. The gate of the FET is connected to the output terminal of 314, while the source of the FET and the anode of the diode are grounded.

The drain of the FET and the cathode of the diode in the parallel circuit 315 are made in common and connected to the midpoint of a series circuit built with a resistor 316 and a capacitor 317. To one end of a resistor 316, a voltage VC is applied. One end of the capacitor 317 is grounded.

The midpoint of the series circuit built with the resistor 316 and the capacitor 317 is connected to the input side of a NOT circuit U1, whose output side is connected to one input side provided in a NAND circuit U3. The output side of the NAND circuit U3 is connected to a conductive wire 318.

The output side of the NAND circuit U3 is connected to one input side provided in a NAND circuit U4.

The midpoint of a series circuit built with a resistor 319 and a capacitor 320 is connected to the input side of an amplifier U8. To one end of the resistor 319, a voltage VC is applied. One end of the capacitor 320 is grounded. The output side of the amplifier U8 is connected to one input side provided in an AND circuit U2.

The other input side provided in the AND circuit U2 is connected to the output side of a NAND circuit U6. The output side of the AND circuit U2 is connected to the other input side provided in the NAND circuit U4.

The output side of the NAND circuit U4 is connected to the other input side provided in the NAND circuit U3. These NAND circuits U3 and U4, and the like compose an RS flip-flop circuit 318a.

The input side of a NOT circuit U7 is connected to the conductive wire 318, and the output side of the NOT circuit U7 is connected to an output terminal 321.

The midpoint of a series circuit built with a resistor 322 and a capacitor 323 is connected to a REXT/CEXT terminal of an integrated circuit device U5. To one end of the resistor 322, a voltage VC is applied. One end of the capacitor 317 is grounded.

To a power supply terminal of the integrated circuit device U5, a voltage VC is applied. A clear (CLR) terminal provided in the integrated circuit device U5 is connected to the conductive wire 318. These integrated circuit device U5, resistor 322, capacitor 323, and the like compose a monostable multivibrator circuit 324.

The conductive wire 318 is connected to one input side provided in the NAND circuit U6 via a resistor 325 and a conductive wire 326. The midpoint of the resistor 325 and the conductive wire 326 is grounded via a capacitor 327.

An output terminal provided in the integrated circuit device U5 is connected to the other input side provided in the NAND circuit U6. The components described thus far compose the recovery part 303.

In FIG. 16, when the temperature of the load part 304 or the temperature of the control part 308, the voltage of the load part 304, and the operation of the control part 308 are all normal, the output terminal 314 outputs a high signal. When at least one of the temperature, the voltage, and the operation all described above is abnormal, the output terminal 314 outputs a low signal.

An initialization circuit 320a including the resistor 319, the capacitor 320, and the amplifier U8 is a circuit that initializes the recovery part 303. When a voltage VC is applied to this initialization circuit 320a, initialization is performed by setting a clear signal CL (signal outputted by the amplifier U8) at a low state.

A circuit including the parallel circuit 315, the resistor 316, the capacitor 317, and the NOT circuit U1 functions such that the NOT circuit U1 does not output a low signal as long as an alert signal AL does not remain as a low signal for more than a predetermined period.

The circuit including the NAND circuits U3 and U4, and the like is the RS flip-flop circuit 318a that holds a state. Even when the output of the NOT circuit U1 changes from a high signal to a low signal, and then returns to a high signal, until a signal fed to the input terminal that is provided in the NAND circuit U4 and that receives an output from the AND circuit U2 turns to a low signal, the RS flip-flop circuit 318a holds the output conditions of the NAND circuits U3 and U4 so that high signals are outputted from the output sides of the NAND circuits U3 and U4.

The circuit including the resistor 322, the capacitor 323, and the integrated circuit device U5 is the monostable multivibrator circuit 324. When an input fed to the clear (CLR) terminal of the integrated circuit device U5 changes from a low signal to a high signal, the monostable multivibrator circuit 324 generates a pulse of a time width that is determined by a time constant of the resistor 322 and the capacitor 323. This pulse provides a period for which a control signal P fed to the output terminal 321 is kept as a low signal.

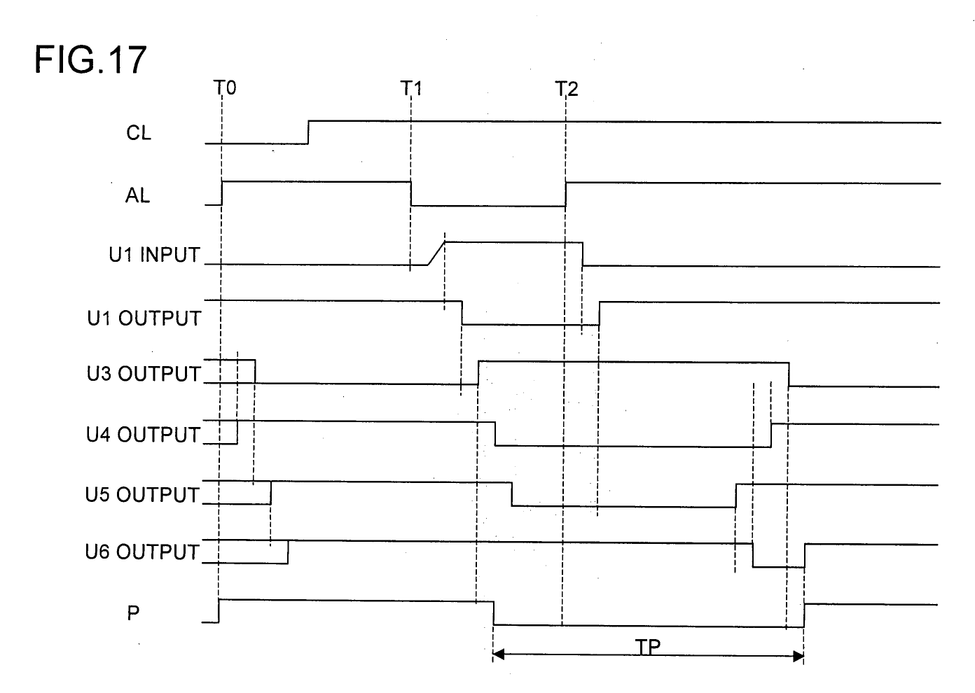

Next, according mainly to a waveform diagram shown in FIG. 17, a description will be given on the operation of this apparatus 301. With a period indicated by the horizontal axis, FIG. 17 is a diagram of voltage waveforms of, from the top, a clear signal CL outputted by the amplifier U8, an alert signal AL fed to the output terminal 314, an input signal fed to the NOT circuit U1 (U1 input), an output signal from the NOT circuit U1 (U1 output), an output signal from the NAND circuit U3 (U3 output), an output signal from the NAND circuit U4 (U4 output), an output signal from the integrated circuit device U5 (signal fed to one input terminal of the NAND circuit U6; U5 output), an output signal from the NAND circuit U6 (U6 output), and a control signal P fed to the output terminal 321.

First, at T0 timing, the user inserts the power plug 306 in the power receptacle (not shown), whereby a commercial supply voltage VI is applied to the first power supply part 305 and also to the second power supply part 307. The second power supply part 307 then starts to supply a voltage VC to the monitoring part 302 and the recovery part 303.

At this point, the initialization circuit 320a outputs a clear signal CL as a low signal for a period determined by a time constant of the resistor 319 and the capacitor 320 to thereby initialize the recovery part 303, and then outputs a high signal.

At the voltage VC application described above, a switching circuit (not shown) including the first power supply part 305 is closed. Now assuming that the temperature of the control part 308, the voltage of the load part 304, and the operation of the control part 308 are all normal at the voltage application described above, the alert signal AL becomes a high signal (see the period from the timing T0 to T1 in FIG. 17). Therefore, the input (U1 input) and the output (U1 output) of the NOT circuit U1 are a low signal and a high signal, respectively upon the start of supplying the voltage VC.

Immediately after the timing T0, upon receiving the clear signal CL as a low signal, the output of the AND circuit U2 becomes a low signal, whereby the output of the NAND circuit U4 (U4 output) changes from its unstable state to a high signal. Subsequently, upon receiving this high signal from the NAND circuit U4, the output of NAND circuit U3 changes from its unstable state to a low signal. Then, upon receiving this low signal from the NAND circuit U3 at its own clear (CLR) terminal, the output of the integrated circuit device U5 (U5 output) changes from its unstable state to a high signal. Then, upon receiving this high signal from the integrated circuit device U5 and the low signal from the NAND circuit U3, the output of the NAND circuit U6 (U6 output) changes from its unstable state to a high signal.

By connecting a pull-up resistor (not shown) to the output terminal 321, a control signal P fed to the output terminal 321 is adapted to turn to a high signal as soon as the voltage VC is applied, so that the high signal is kept even after the output of the NAND circuit U3 changes from its unstable state to be fixed as the low signal.

Assume that, for example, the control part 308 runs out of control at the timing T1 after the clear signal CL has changed to a high state. At this timing T1, the monitoring part 302 detects that the load part 304 and/or the control part 308 is abnormal. More specifically, the monitoring part 302 detects that at least one of the temperature of the load part 304 or the control part 308, the voltage of the load part 304, and the operation of the control part 308 is abnormal. At this point, the alert signal AL changes from a high signal to a low signal (see the alert signal AL in FIG. 17).

When the alert signal AL remains as a low signal for more than a predetermined period, the circuit including the parallel circuit 315, the resistor 316, the capacitor 317, and the NOT circuit U1 switches from the high signal, and outputs a low signal (see the U1 output in FIG. 17).

Thus, when the output of the NOT circuit U1 (U1 output) changes from a high signal to a low signal, the output of the NAND circuit U3 (U3 output) changes form a low signal to a high signal, and then the output of the NAND circuit U4 (U4 output) changes from a high signal to a low signal.

In addition, at this point, the control signal P fed to the output terminal 321 connected to the output side of the NAND circuit U3 via the NOT circuit U7 switches from a high signal to a low signal. This control signal P is then fed to the first power supply part 305.

Upon receiving this control signal P which has been switched to a low signal, the first power supply part 305 stops the supply of a voltage VT to the load part 304 and the supply of a voltage VP to the control part 308. The monitoring part 302 is configured such that the alert signal AL changes from a low signal back to a high signal (timing T2) when these supplies are stopped. When the alert signal AL changes back to a high signal, the input of the NOT circuit U1 (U1 input) switches to a low signal, and subsequently the output of the NOT circuit U1 (U1 output) switches to a high signal.

When the output of the NAND circuit U3 (U3 output) changes from a low signal to a high signal, a signal fed to the clear (CLR) terminal of the integrated circuit device U5 switches from a low signal to a high signal.

At this point, the monostable multivibration circuit 324 generates a pulse in a low state having a duration determined by the time constant of the resistor 322 and the capacitor 323.

More specifically, when the output of the NAND circuit U3 (U3 circuit) changes from a low signal to a high signal, the output of the integrated circuit device U5 (U5 output) changes from a high signal to a low signal, and then output the low signal for a predetermined period. At this point, the NAND circuit U6 continuously outputs a high signal (see the U6 output in FIG. 17).

When the time period determined by the time constant of the resistor 322 and the capacitor 323 has elapsed, the output of the integrated circuit device U5 (U5 output) changes from a low signal to a high signal, upon which the output of the NAND circuit U6 (U6 output) switches to a low signal. Subsequently, the output of the NAND circuit U4 (U4 output) switches to a high signal, and the output of the NAND circuit U3 (U3 output) switches to a low signal. Further, the output of the NAND circuit U6 (U6 output) switches to a high signal, and the control signal P switches to a high signal, whereby the circuit as a whole returns to its original state (state immediately before the timing T1).

In this case, the period for which the output of the NAND circuit U3 (U3 output) stays as a high signal is equal to the period for which the control signal P stays as a low signal. Thus, when a predetermined period TP has elapsed after the control signal P turns to a low signal, the control signal P changes back to a high signal. This predetermined period TP is in accordance with the time constant of the resistor 322 and the capacitor 323.

The control signal P generated by the recovery part 303 is fed to the switching circuit included in the first power supply part 305 via the control terminal included in the first power supply part 305.

When the control signal P is a high signal, the switching circuit included in the first power supply part 305 is closed, so that the first power supply part 305 feeds VT and VP as supply voltages to the load part 304 and the control part 308. On the other hand, when the control signal P is a low signal, the switching circuit included in the first power supply part 305 is opened, so that the first power supply part 305 stops supplying the voltages to both the load part 304 and the control part 308.

As a result, when the monitoring part 302 detects the abnormality of the load part 304 and/or the control part 308, the recovery part 303 stops the power supply provided by the first power supply part 305.

More specifically, when the monitoring part 302 detects that at least one of the temperature of the load part 304 or the control part 308, the voltage of the load part 304, and the operation of the control part 308 is abnormal, the monitoring part 302 outputs, to the recovery part 303, an alert signal AL which has changed from a high signal to a low signal.

Then, the recovery part 303 outputs, to the first power supply part 305, the control signal P which has changed from a high signal to a low signal, whereby the switching circuit of the first power supply part 305 opens. That is, the first power supply part 305 stops the supply of the voltage VT to the load part 304, and also stops the supply of the voltage VP to the control part 308.

When the predetermined period TP (for example, approximately 10 seconds) has elapsed after the supply of the voltages VT and VP are stopped, the recovery part 303 outputs, to the first power supply part 305, the control signal P which has changed from a low signal to a high signal. As a result, the switching circuit of the first power supply part 305 is closed, and the first power supply part 305 restart the supply of the voltage VT to the load part 304 and the supply of the voltage VP to the control part 308.

### Modified Embodiment

The first to fourth embodiments described above can be combined together as long as no inconsistency arises. For example, the electrical configuration featuring the apparatus 301 in the fourth embodiment is applicable to the display apparatus 1 in the first embodiment, the display apparatus 101 in the second embodiment, or the display apparatus 201 in the third embodiment.

### INDUSTRIAL APPLICABILITY

The present invention (first aspect of the invention) is preferable as a highly reliable display apparatus having a power supply part whose temperature increase is controlled. This display apparatus can be used as a display apparatus provided with a liquid crystal panel, a cathode-ray tube, or the like, or a display apparatus, such as a plasma display, an organic electroluminescence display, or the like.

The present invention (second aspect of the invention) is preferable as a low-cost display apparatus that can read and write a large volume of data and has an easily removable storage unit. This display apparatus can be used as a display apparatus provided with a liquid crystal panel, a cathode-ray tube, or the like, or a display apparatus, such as a plasma display, an organic electroluminescence display, or the like.

The present invention (third aspect of the invention) is preferable as a display apparatus that permits easy replacement of a connector and the like in the event of destination change. This display apparatus can be used as a display apparatus provided with a liquid crystal panel, a cathode-ray tube, or the like, or a display apparatus, such as a plasma display, an organic electroluminescence display, or the like.

The present invention (fourth aspect of the invention) is preferable as a display apparatus or an apparatus provided with a protection circuit which detects that the voltage of a load, the temperature of the load or a control part, or the operation of the control part is abnormal, then stops power supply, and subsequently permits automatic recovery. This display apparatus or the apparatus provided with a protection circuit can be used as a display apparatus provided with a liquid crystal panel, a cathode-ray tube, or the like, or a display apparatus, such as a plasma display, an organic electroluminescence display, or the like.

1. A display apparatus comprising: a casing in which a first lower vent and a first upper vent are formed; a liquid crystal display part that is arranged on a front surface side in the casing; a first power supply part that is arranged on a rear surface side in the casing and supplies a power source to a backlight of the liquid crystal display part; and a first cooling fan that is arranged on the rear surface side in the casing so as to be located near the first upper vent,
wherein a first circuit board included in the first power supply part is so arranged as to be tilted with respect to a first side surface of the casing.

2. The display apparatus according to claim 1,
wherein a first partition plate is provided adjacent to the first cooling fan and the first power supply part, wherein a first opening is provided in the first partition plate, and wherein suction air suctioned by the first cooling fan enters through the first lower vent, passes through the first opening, a vicinity of the first power supply part, and the first cooling fan, and then is discharged through the first upper vent.

3. The display apparatus according to claim 1,
wherein a second upper vent is provided in the casing, wherein a second power supply part is provided which is arranged on the rear surface side in the casing and supplies a power source to a driving part of the liquid crystal display part, wherein a second cooling fan is provided on the rear surface side in the casing so as to be located near the second upper vent, and wherein a second circuit board included in the second power supply part is so arranged as to be tilted with respect to a second side surface of the casing which second side surface faces the first side surface.

4. The display apparatus according to claim 3,
wherein a second partition plate is provided adjacent to the second cooling fan and the second power supply part, wherein a second opening is provided in the second partition plate, and wherein first suction air suctioned by the second cooling fan enters through the first lower vent, passes through the second opening, a vicinity of the second power supply part, and the second cooling fan, and then is discharged through the second upper vent.

5. The display apparatus according to claim 4,
wherein a second lower vent is formed in the casing so as to be located below the second power supply part, and wherein second suction air suctioned by the second cooling fan enters through the second lower vent, passes through a vicinity of the second power supply part and the second cooling fan, and then is discharged through the second upper vent.

6. A display apparatus comprising: a main body that is formed in a substantially box-like shape and has a first opening formed in a rear surface side thereof; a liquid crystal display part that is arranged on a front surface side in the main body; a board assembly that is arranged in the main body and outputs an image signal to the liquid crystal display part; a shield plate that covers the board assembly; and a hard disc drive that is fixed to the shield plate and performs data reading and writing,
wherein the hard disc drive is so provided as to be removable through the first opening.

7. The display apparatus according to claim 6,
wherein a cover is provided which covers the first opening, and wherein the cover is so provided as to be removable from the main body.

8. The display apparatus according to claim 6,
wherein a reinforcing plate is provided which is in contact with opposing inner surfaces of the main body, wherein a mounting plate is provided which is supported by the reinforcing plate, and wherein a circuit board included in the board assembly is supported by the mounting plate.

9. The display apparatus according to claim 8,
wherein a second opening is formed in the shield plate so as to be located below the hard disc drive, wherein a memory is fixed to the circuit board so as to be located below the second opening, and wherein the memory is so provided as to be removable.

10. A display apparatus comprising: a box-like main body in which a first opening is formed; a liquid crystal panel that is arranged in the main body; a first connecter that supplies a power source for the liquid crystal panel and has a conductive pin or a conductive tube formed on a front surface side thereof in a predetermined shape; a first fixing plate that fixes the first connector so that a rear surface side of the first connector protrudes into the main body through the first opening,
wherein the first fixing plate is removably fixed to the main body so that the front surface side of the first connector is exposed.

11. The display apparatus according to claim 10,
wherein a power switch is provided which is electrically connected to the first connector, wherein the first fixing plate fixes the power switch so that a rear surface side of the power switch protrudes into the main body through the first opening; and wherein the first fixing plate is removably fixed to the main body so that a front surface side of the power switch is exposed.

12. The display apparatus according to claim 11,
wherein a first vertical wall is formed in the main body, wherein the first opening is formed in the first vertical wall, wherein a first horizontal portion, a first vertical portion, a pawl, a second opening, and a third opening are formed in the first fixing plate, wherein the first connector is inserted in and then fixed in the second opening, wherein the power switch is inserted in and then fixed in the third opening, wherein the first horizontal portion is fixed to a rear portion of the main body with a first fastening component, and wherein the pawl is stuck in and then fixed to the first vertical wall located near the first opening.

13. The display apparatus according to claim 10,
wherein a fourth opening is formed in the main body, wherein there are provided: a second connector that has a second conductive tube formed on a front surface side thereof in a predetermined shape and that is electrically connected to the first connector; and a second fixing plate that fixes the second connector so that a rear surface side of the second connector protrudes into the main body through the fourth opening, and wherein the second fixing plate is removably fixed to the main body so that the front surface side of the second connector is exposed.

14. The display apparatus according to claim 13,
wherein a second vertical wall is formed in the main body, wherein the fourth opening is formed in the second vertical wall, wherein a second horizontal portion, a second vertical portion, a bending portion, and a fifth opening are formed in the second fixing plate, wherein the second connector is inserted in and then fixed in the fifth opening, wherein the second horizontal portion is fixed to a rear portion of the main body with a second fastening component, and wherein the bending portion is fixed so that the bending portion comes into contact with an inner surface of the second vertical wall located near the fourth opening.

15. A display apparatus comprising: a load part that has at least a display part; a first power supply part that supplies a power source to the load part; a control part that is supplied with a power source by the first power supply part and controls the load part; a monitoring part that monitors the load part and the control part; and a recovery part that controls the first power supply part,
wherein, when the monitoring part detects abnormality of the load part and/or the control part, the recovery part stops the supply of the power sources to the load part and the control part by the first power supply part.

16. The display apparatus according to claim 15,
wherein, when the monitoring part detects that at least one of a temperature of the load part or the control part, a voltage of the load part, and an operation of the control part is abnormal, the recovery part stops the supply of the power sources to the load apart and the control part by the first power supply part.

17. The display apparatus according to claim 15,
wherein, when a predetermined period elapses after the supply of the power sources is stopped, the recovery part restarts the supply of the power sources to the load part and the control part by the first power supply part.

18. The display apparatus according to claim 15,
wherein a second power supply part is provided whose input side is connected to a power plug, wherein an input side of the first power supply part is connected to the power plug, and wherein an output side of the second power supply part is connected to the recovery part.
